(19) United States
(12) Patent Application Publication
(10) Pub. No.: US 2026/0323672 A1
(43) Pub. Date: Oct. 15, 2026

(54) METHODS AND SYSTEMS OF SIDELINK OPERATIONS FOR BEAM-BASED MODE 2 HARQ IN SHARED SPECTRUM

(71) Applicant: INTERDIGITAL PATENT HOLDINGS, INC., Wilmington, DE (US)

(72) Inventors: Kyle Jung-Lin PAN, Saint James, NY (US); Ravikumar PRAGADA, Warrington, PA (US); Yifan LI, Conshohocken, PA (US); Pascal ADJAKPLE, Great Neck, NY (US)

(73) Assignee: INTERDIGITAL PATENT HOLDINGS, INC., Wilmington, DE (US)

(21) Appl. No.: 19/118,435

(22) PCT Filed: Oct. 5, 2023
(86) PCT No.: PCT/US2023/076079

§ 371 Date: Apr. 4, 2025

Related U.S. Application Data
(60) Provisional application No. 63/413,448, filed on Oct. 5, 2022.

(51) Int. Cl. H04W 72/40; H04L 1/1812; H04W 72/25

(52) U.S. Cl. CPC H04W 72/40; H04L 1/1812; H04W 72/25

(57) ABSTRACT

Described are systems and methods for sidelink (SL) hybrid automatic repeat request (HARQ) feedback schemes. A wireless transmit/receive unit (WTRU) may receive information that indicates a plurality of SL transmission configuration indications (TCIs), wherein the SL TCIs include at least a SL primary TCI (P-TCI) and a SL secondary TCI (S-TCI), and information that indicates a plurality of hybrid automatic repeat request (HARQ) configurations. The WTRU may determine a channel uncertainty and determine, based on a comparison of the channel uncertainty to at least one threshold value, a combination of a set of SL TCIs and a HARQ configuration to use for communicating via a sidelink feedback channel. The WTRU may send a transmission, via a sidelink feedback channel, using the determined set of SL TCIs and using the determined HARQ configuration.

### RELATED APPLICATIONS

The present application claims the benefit of and priority to U.S. Provisional Patent Application No. 63/413,448, entitled “Methods and Systems of Sidelink Operations for Beam-based Mode 2 HARQ in Shared Spectrum,” filed Oct. 5, 2022, the entirety of which is incorporated by reference herein.

### BACKGROUND

New Radio (NR) vehicle-to-everything (V2X) is designed with a broader set of more advanced V2X use cases in mind and are broadly arranged into four use case groups: vehicular platooning, extended sensors, advanced driving, and remote driving.

Vehicles Platooning enables the vehicles to dynamically form a platoon travelling together. All the vehicles in the platoon obtain information from the leading vehicle to manage the platoon. This information allows the vehicles to drive closer than normal in a coordinated manner, going to the same direction and travelling together.

Extended Sensors enable the exchange of raw or processed data gathered through local sensors or live video images among vehicles, road site units, devices of pedestrian and V2X application servers. The vehicles can increase the perception of their environment beyond of what their own sensors can detect and have a more broad and holistic view of the local situation. High data rate is one of the key characteristics.

Advanced Driving enables semi-automated or full-automated driving. Each vehicle and/or road side unit (RSU) shares its own perception data obtained from its local sensors with vehicles in proximity and that allows vehicles to synchronize and coordinate their trajectories or maneuvers. Each vehicle also shares its driving intention with vehicles in proximity.

Remote Driving enables a remote driver or a V2X application to operate a remote vehicle for those passengers who cannot drive by themselves, or remote vehicles located in dangerous environments. For a case where variation is limited and routes are predictable, such as public transportation, driving based on cloud computing can be used. High reliability and low latency are the main requirements.

These and other implementations may utilize high frequencies (e.g. above 52.6 GHz in some instances). Such implementations are faced with more difficult challenges, such as higher phase noise, larger propagation loss due to high atmospheric absorption, lower power amplifier efficiency, and strong power spectral density regulatory requirements in unlicensed bands, compared to lower frequency bands. Additionally, the frequency ranges above 52.6 GHz potentially contain larger spectrum allocations and larger bandwidths that are not available for bands lower than 52.6 GHz.

In some communications systems using beam-based sidelinks (e.g. for communication between vehicles in a V2X application), due to channel uncertainty, a signal may not be properly transmitted due to listen-before-talk (LBT) failure in some spatial directions. Even if the signal can be transmitted, it may not be received due to interference (e.g., from a hidden node in the same spatial direction). Some implementations of Hybrid Automatic Repeat Request (HARQ) may help address this, but may raise additional issues: for example, in some instances a negative or non-acknowledgement (NACK)-based HARQ technique may be utilized in which a NACK is sent if a signal is not received. However, if the NACK itself is not received, then the signal sender may incorrectly assume successful transmission. This results in system error and performance degradation.

### SUMMARY

To address the above-discussed and other issues, in some aspects, the present disclosure is directed to systems and methods of sidelink (SL) beam-based mode 2 operation for HARQ. A hybrid acknowledgement/non-acknowledgement (ACK/NACK) scheme may be used with ACKs utilized in addition to (or instead of, depending on implementation) NACKs when LBT failure or channel uncertainty (due to noise, interference, low signal levels, etc.) is high, and with a NACK-only scheme used for high throughput and low latency when LBT failure or channel uncertain is low. In various implementations, ACKs and/or NACKs may be grouped or identify a plurality of received or missing signals, or individual ACKs or NACKs (i.e. one per signal or sequence number) may be utilized. This may be similarly based on channel uncertainty or LBT failure, or any other channel or device condition or characteristic, in various implementations. Accordingly, devices may dynamically switch between a plurality of HARQ configurations in response to changing channel conditions (e.g., ACK/NACK feedback scheme, NACK-only feedback scheme, shared ACK/NACK feedback scheme, etc.).

A method may comprise receiving configuration information regarding a plurality of sets of SL transmission configuration indications (TCIs) and a plurality of hybrid automatic repeat request (HARQ) feedback schemes. The method may further comprise determining channel uncertainty based on at least one measurement and at least one threshold. The configuration information may further comprise a plurality of HARQ feedback resources. The method may further comprise receiving an indication of a TCI to use for transmitting a physical sidelink feedback channel (PSFCH) transmission. The method may further comprise selecting a TCI type based on the determined channel uncertainty. The method may further comprise selecting a HARQ feedback scheme based on the determined channel uncertainty. The method may further comprise selecting a feedback resource based on the determined channel uncertainty. The method may further comprise transmitting HARQ feedback over a physical sidelink feedback channel (PSFCH) using the indicated TCI, the selected HARQ feedback scheme, and the selected feedback resource. The plurality of sets of TCIs may comprise a primary TCI (P-TCI) and a secondary (S-TCI). The plurality of HARQ feedback schemes may comprise an ACK/NACK scheme and a NACK-only scheme. The method may further comprise using a large set of TCIs on a condition that the channel uncertainty is greater than a first threshold. The method may further comprise switching to an individual ACK-NACK HARQ feedback scheme on a condition that the channel uncertainty is greater than a second threshold. The method may further comprise transmitting an individual

ACK or NACK based on decoding results. The method may further comprise switching to a NACK-only HARQ feedback scheme on a condition that the channel uncertainty is not greater than a second threshold. The method may further comprise transmitting a NACK-only if decoding fails. The method may further comprise switching to NACK-only HARQ feedback scheme on a condition that the channel uncertainty is not greater than a second threshold. The method may further comprise using a small set of TCIs on a condition that the channel uncertainty is greater than a first threshold. The method may further comprise switching to a NACK-only HARQ feedback scheme on a condition that the channel uncertainty is not greater than a first threshold. The method may further comprise switching to an individual ACK/NACK HARQ feedback scheme on a condition that the channel uncertainty is greater than a third threshold. The large set of TCIs may comprise a primary TCI (P-TCI) and a secondary TCI (S-TCI). The small set of TCIs may comprise a primary TCI (P-TCI). In addition, the large set of TCIs may comprise a large primary TCI (P-TCI) set only or a large secondary TCI (S-TCI) set only. The small set of TCIs may comprise a small secondary TCI (S-TCI) set. The channel uncertainty may be determined based on at least one of: a number of listen before talk (LBT) failures, a ratio of LBT failures to a total measurement, a ratio of LBT failures to successes, a NACK to ACK ratio, a percentage of NACKs, a channel busy ratio (CBR), and an interference level.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example of 5G V2X and LTE V2V requirements;

FIG. 3 shows an example method of sidelink TCI based HARQ feedback;

FIG. 4 shows an example method of sidelink TCI based HARQ feedback;

FIG. 5 is an example method of sidelink TCI based HARQ feedback with hybrid TCI and HARQ feedback;

FIG. 6 is an example method of sidelink TCI based HARQ feedback with hybrid TCI and HARQ feedback;

FIG. 7 shows an example method of sidelink TCI based HARQ feedback with a multi-threshold scheme;

FIG. 8 shows an example method of sidelink TCI based HARQ feedback with hybrid TCI and HARQ feedback;

FIG. 9 shows an example method of sidelink TCI based HARQ feedback with hybrid TCI and HARQ feedback;

FIG. 10 shows an example method of sidelink TCI based HARQ feedback with a multi-threshold scheme;

FIG. 11 shows an example method of sidelink TCI based HARQ feedback with hybrid TCI and HARQ feedback;

FIG. 12 shows an example method of sidelink TCI based HARQ feedback with a multi-threshold scheme;

FIG. 13 shows an example method of a hybrid scheme using TCI, HARQ feedback and resource allocation;

FIG. 14 shows an example method of sidelink TCI based HARQ feedback with a multi-threshold scheme;

FIG. 15 shows an example method of sidelink UE-assisted TCI and HARQ feedback;

FIG. 16 shows an example method of sidelink UE-controlled TCI and HARQ feedback;

FIG. 17 shows an example method of sidelink UE-controlled TCI and HARQ feedback;

FIG. 18 shows an example method of TCI indication and feedback scheme indication; and

FIG. 19 shows an example method of TCI indication and feedback scheme indication with a SL configurable control container.

### DETAILED DESCRIPTION

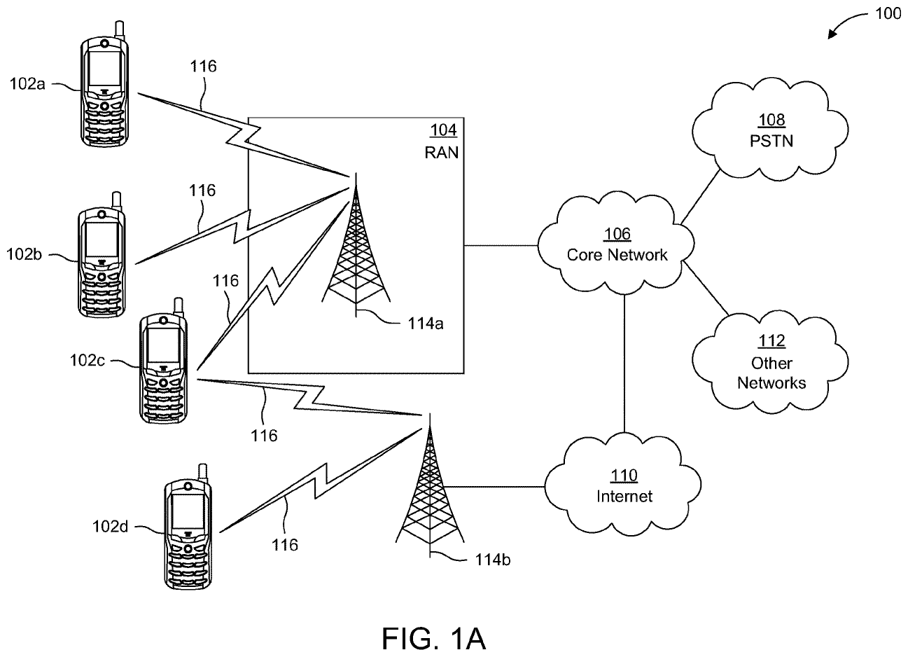

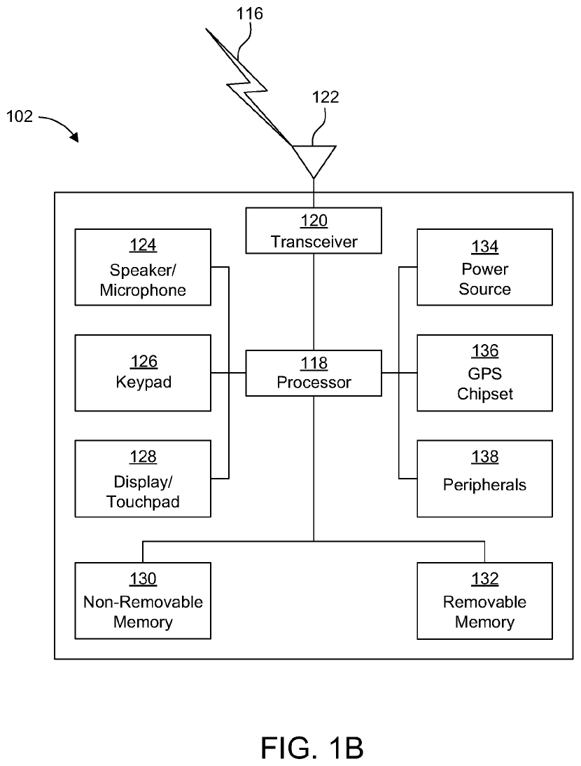

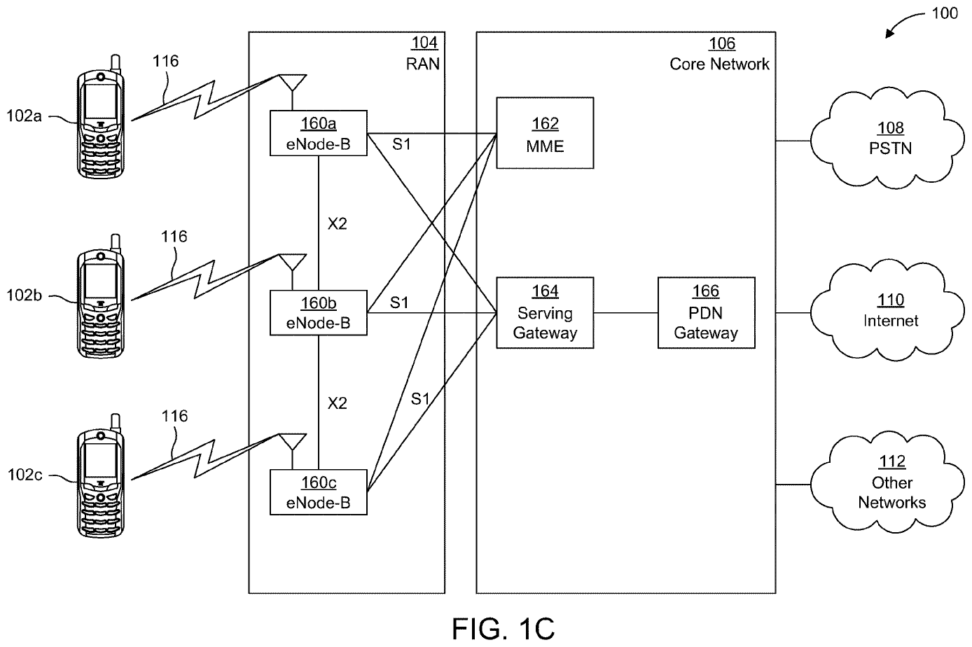

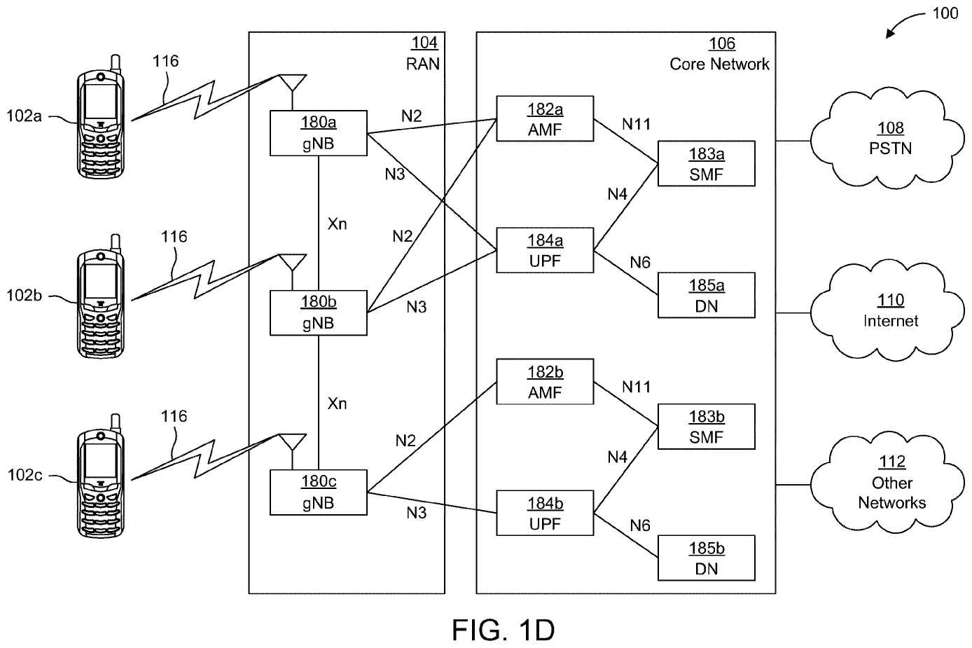

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
ACK ACKnowledgement
BWP Bandwidth Part
CC Component Carrier
CCG Component Carrier Group
CE Control Element
CRC Cyclic Redundancy Check
CSI Channel State Information
DCI Downlink Control Information
DMRS DeModulation Reference Signal
DL Downlink
HARQ Hybrid Automatic Repeat Request
IE Information Element
LTE Long Term Evolution
MAC Medium Access Control
MIB Master Information Block
Non-ACKnowledgement NACK
NR New Radio
PIR Packet Inter-Reception
PRB Physical Resource Block
PRR Packet Reception Ratio
PSBCH Physical Sidelink broadcast Channel
PSCCH Physical Sidelink Control Channel
PSFCH Physical Sidelink Feedback Channel
PSSCH Physical Sidelink Shared Channel
QoS Quality of Service
RAN Radio Access Network
RB Resource Block
RBG Resource Block Group
RNTI Radio Network Temporary Identifier
RRC Radio Resource Control
RSRP Reference Signal Receive Power
RSU Road Side Unit
S-SSB Sidelink Synchronization Signal Block
S-RSRP Sidelink Reference Signal Receive Power
S-RSSI Sidelink Received Signal Strength Indicator
SCI Sidelink Control Information
SFI Slot Format Indicator
SI System Information
SINR Signal to Interference and Noise Ratio
SL Sidelink
SNR Signal to Noise Ratio
TCI Transmission Configuration Indication
TB Transport Block
UE User Equipment
UL Uplink
V2V Vehicle-to-Vehicle
V2X Vehicle-to-everything

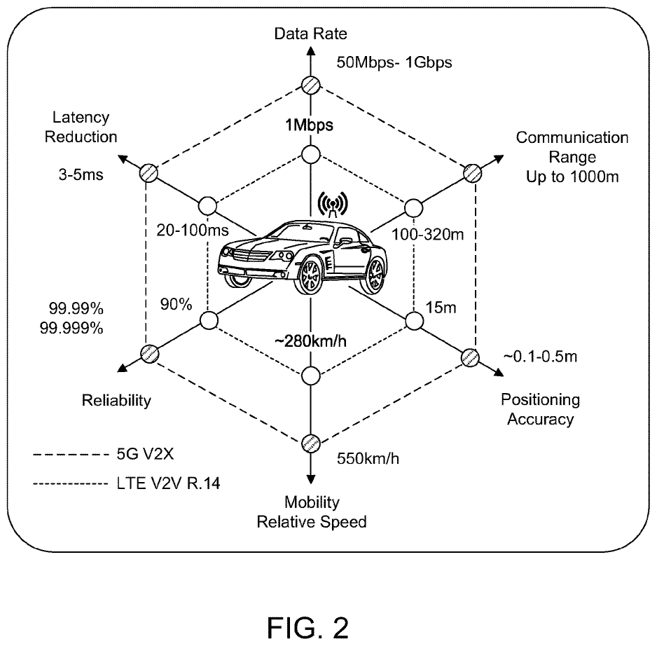

FIG. 2 shows an example of 5G NR V2X requirements and LTE V2V requirements. The most demanding requirements set are for a maximum sidelink range of 1000 m, a maximum throughput of 1 Gbps, a shortest latency of 3 ms, a maximum reliability of 99.999%, and a maximum transmission rate of 100 messages/second. Other challenging requirements may also include mobility relative speed and positioning accuracy. However, there is not a use case which, on its own, demands all of these bounding requirements. There are also requirements relating to security, integrity, authorization, and privacy.

5G NR V2X has physical layer support for broadcast, unicast, and groupcast sidelink operation. The addition of unicast and groupcast is linked with the introduction of sidelink HARQ feedback, high order modulation, sidelink CSI, and PC5-RRC.

The 5G NR V2X sidelink uses the following physical channels and signals: physical sidelink broadcast channel (PSBCH) and its DMRS; physical sidelink control channel (PSCCH) and its DMRS; physical sidelink shared channel (PSSCH) and its DMRS; physical sidelink feedback channel (PSFCH); sidelink primary and secondary synchronization signals (S-PSS and S-SSS) which are organized into the sidelink synchronization signal block (S-SSB) together with PSBCH, where S-PSS and S-SSS may be referred to jointly as the sidelink synchronization signal (SLSS); phase-tracking reference signal (PT-RS) in FR2; and channel state information reference signal (CSI-RS).

5G NR-V2X sidelink supports subcarrier spacings of 15, 30, 60, and 120 kHz. Their associations to CPs and frequency ranges are as for NR UL/DL, but using only the CP-OFDM waveform. The modulation schemes available are QPSK, 16-QAM, 64-QAM, and 256-QAM.

PSBCH transmits the SL-BCH transport channel, which carries the sidelink V2X Master Information Block (MIB-V2X) from the RRC layer. When in use, PSBCH transmits MIB-V2X every 160 ms in 11 RBs of the SL bandwidth, with possible repetitions in the period. DMRS associated with PSBCH are transmitted in every symbol of the S-SSB slot. S-PSS and S-SSS are transmitted together with PSBCH in the S-SSB. They jointly convey the SLSS ID used by a UE.

Sidelink control information (SCI) in 5G NR V2X is transmitted in two stages. A first-stage SCI is carried on PSCCH and comprises information to enable sensing operations, as well as information about the resource allocation of the PSSCH.

PSSCH transmits a second-stage SCI and the SL-SCH transport channel. The second-stage SCI carries information needed to identify and decode the associated SL-SCH, as well as control for HARQ procedures, and triggers for CSI feedback, etc. A SL-SCH carries the TB of data for transmission over SL.

The resources in which a PSSCH is transmitted may be scheduled or configured by a gNB or determined through a sensing procedure conducted autonomously by a transmitting UE. A given TB may be transmitted multiple times. DMRS associated with rank-1 or rank-2 PSSCH may be transmitted in 2, 3, or 4 sidelink symbols distributed through a sidelink slot. Multiplexing between PSCCH and PSSCH may be in time and frequency within a slot.

A PSFCH carries HARQ feedback over the sidelink from a UE which is an intended recipient of a PSSCH transmission (herein referred to as a Rx UE) to the UE which performed the transmission (herein referred to as a Tx UE). Sidelink HARQ feedback may be in the form of a conventional ACK/NACK, or NACK-only with nothing transmitted in case of successful decoding. A PSFCH transmits a Zadoff-Chu sequence in one PRB repeated over two OFDM symbols, the first of which may be used for AGC, near the end of the sidelink resource in a slot. The time resources for PSFCH are configured/pre-configured to occur once in every 1, 2, or 4 slots.

A resource allocation mode 1 may be for resource allocation by a gNB. The use cases intended for 5G NR V2X may generate a diverse array of periodic and aperiodic message types. Therefore, resource allocation mode 1 provides dynamic grants of sidelink resources from a gNB, as well as grants of periodic sidelink resources configured semi-statically by RRC.

A dynamic sidelink grant DCI may provide resources for one or multiple transmissions of a transport block, in order to allow control of reliability. The transmission(s) may be subject to a sidelink HARQ procedure, if that operation is enabled.

A sidelink configured grant may be such that it is configured once and may be used by the UE immediately, until it is released by RRC signaling (known as Type 1). A UE is allowed to continue using this type of sidelink configured grant when beam failure or physical layer problems occur in NR Uu until an RLF detection timer expires, before falling back to an exception resource pool. The other type of sidelink configured grant (known as Type 2) is configured once but cannot be used until the gNB sends the UE a DCI indicating it is now active, and only until another DCI indicates de-activation. The resources in both types are a set of sidelink resources recurring with a periodicity which a gNB will desire to match to the characteristics of the V2X traffic. Multiple configured grants may be configured to allow provision for different services, traffic types, etc.

MCS information for dynamic and configured grants may optionally be provided or constrained by RRC signaling instead of a traditional DCI. RRC may configure the exact MCS the Tx UE uses, or a range of MCS. It may also be left unconfigured. For the cases where RRC does not provide the exact MCS, the Tx UE is left to select an appropriate MCS itself based on the knowledge it has of the TB to be transmitted and, potentially, the sidelink radio conditions.

Resource allocation mode 2 may be for UE autonomous resource selection. Its basic structure is of a UE sensing, within a (pre-) configured resource pool, which resources are not in use by other UEs with higher-priority traffic, and choosing an appropriate amount of such resources for its own transmissions. Having selected such resources, the UE may transmit and re-transmit in them a certain number of times, or until a cause of resource reselection is triggered.

The mode 2 sensing procedure may select and then reserve resources for a variety of purposes reflecting that NR V2X introduces sidelink HARQ in support of unicast and groupcast in the physical layer. It may reserve resources to be used for a number of blind (re-)transmissions or HARQ-feedback-based (re-)transmissions of a transport block, in which case the resources are indicated in the SCI(s) scheduling the transport block. Alternatively, it may select resources to be used for the initial transmission of a later transport block, in which case the resources are indicated in an SCI scheduling a current transport block. Finally, an initial transmission of a transport block may be performed after sensing and resource selection, but without a reservation.

The first-stage SCIs transmitted by UEs on a PSCCH indicate the time-frequency resources in which the UE will transmit a PSSCH. These SCI transmissions are used by sensing UEs to maintain a record of which resources have been reserved by other UEs in the recent past.

The sensing UE may then select resources for its (re-)transmission(s) from within a resource selection window. The window may start shortly after the trigger for (re-) selection of resources, and cannot be longer than the remaining latency budget of the packet due to be transmitted. Reserved resources in the selection window with SL-RSRP above a threshold are excluded from being candidates by the sensing UE, with the threshold set according to the priorities of the traffic of the sensing and transmitting UEs. Thus, a higher priority transmission from a sensing UE may occupy resources which are reserved by a Tx UE with sufficiently low SL-RSRP and sufficiently lower-priority traffic

BWPs are defined for the sidelink in a similar way as for UL/DL, to provide a convenient way to specify aspects relating to a UEs RF hardware chain implementation. A UE may be configured with one active sidelink BWP when in connected mode to a gNB, which is the same as the single sidelink BWP used for idle mode or out-of-coverage operation.

The subcarrier spacing used on sidelink is provided in the sidelink BWP (pre-) configuration, from the same set of values and associations to frequency ranges as for the Uu interface (i.e. 15, 30, or 60 kHz for FR1; and 60 or 120 kHz for FR2). Sidelink transmission and reception for a UE are thus contained within a sidelink BWP, and the same sidelink BWP is used for both transmitting and receiving. This means that resource pools, S-SSB, etc. must also be contained within an appropriate sidelink BWP from the UE's perspective.

In order to support wide range of services, a 5G NR system aims to be flexible enough to meet the connectivity requirements of a range of existing and future (as yet unknown) services to be deployable in an efficient manner. In particular, NR considers supporting potential use of a frequency range up to 100 GHz.

5G NR specifications that have been developed in Rel-15 and Rel-16 define operation for frequencies up to 52.6 GHz, where all physical layer channels, signals, procedures, and protocols are designed to be optimized for uses under 52.6 GHz.

However, frequencies above 52.6 GHz are faced with more difficult challenges, such as higher phase noise, larger propagation loss due to high atmospheric absorption, lower power amplifier efficiency, and strong power spectral density regulatory requirements in unlicensed bands, compared to lower frequency bands. Additionally, the frequency ranges above 52.6 GHz potentially contain larger spectrum allocations and larger bandwidths that are not available for bands lower than 52.6 GHz.

As an initial effort to enable and optimize a 3GPP 5G NR system for operation in above 52.6 GHZ, 3GPP RAN has studied requirements for NR beyond 52.6 GHz up to 114.25 GHz including global spectrum availability and regulatory requirements (including channelization and licensing regimes), potential use cases and deployment scenarios, and NR system design requirements and considerations on top of regulatory requirements. The potential use cases identified in the study include high data rate eMBB, mobile data offloading, short range high-data rate D2D communications, broadband distribution networks, integrated access backhaul (IAB), factory automation, industrial IoT (IloT), wireless display transfer, augmented reality (AR)/virtual reality (VR) wearables, intelligent transport systems (ITS) and V2X, data center inter-rack connectivity, smart grid automation, private networks, and support of high positioning accuracy. The use cases span over several deployment scenarios identified in the study. The deployment scenarios include, but not limited to, indoor hotspot, dense urban, urban micro, urban macro, rural, factor hall, and indoor D2D scenarios. The study also identified several system design requirements around waveform, MIMO operation, device power consumption, channelization, bandwidth, range, availability, connectivity, spectrum regime considerations, and others.

Among the frequencies of interest, frequencies between 52.6 GHZ and 71 GHz are especially interesting relatively in the short term because of their proximity to sub-52.6 GHz for which the current NR system is optimized and the imminent commercial opportunities for high data rate communications, e.g., unlicensed spectrum but also licensed spectrum between 57 GHz and 71 GHz.

5G NR rel-15 defined two frequency ranges for operation: FR1 spanning from 410 MHz to 7.125 GHZ, and FR2 spanning from 24.25 GHz to 52.6 GHz.

The proximity of this frequency range (57-71 GHZ) to FR2 and the imminent commercial opportunities for high data rate communications makes it compelling for 3GPP to address NR operation in this frequency range. In order to minimize the specification burden and maximize the leverage of FR2 based implementations, 3GPP has decided to extend FR2 operation up to 71 GHz with the adoption of one or more new numerologies (i.e., larger subcarrier spacings). That or those new numerologies will be identified by the study on waveform for NR>52.6 GHz. NR-U defined procedures for operation in unlicensed spectrum will also be leveraged towards operation in the unlicensed 60 GHz band. NR operation may support up to 71 GHz considering, both, licensed and unlicensed operation, Similar to regular NR and NR-U operations below 52.6 GHZ, NR/NR-U operation in the 52.6 GHz to 71 GHz may be in stand-alone or aggregated via CA or DC with an anchor carrier.

In release-16 New Radio Unlicensed (NR-U), the supported numerology (i.e. subcarrier spacing (SCS)) is set as 15, 30 and 60 KHz. respectively. The listen before talk (LBT) bandwidth is set to 20 MHz in release-16 NR-U. Based on the minimum LBT bandwidth must be supported, the DL initial BWP is nominally 20 MHz for rel-16 NR-U. The maximum supported channel bandwidth is set to 100 MHz. The UE channel bandwidth (or an activated BWP) may be set as an integer multiple of LBT bandwidth (i.e. 20 MHz). For instance, for SCS=30 KHz, the total allocated PRB numbers for 20 MHz, 40 MHz and 80 MHz bandwidth is equal to 48, 102, and 214, respectively.

Rel-18 will cover sidelink communication with FR1 unlicensed channel access (no beam management) for mode 2 and FR2 licensed operation with beam management. However, only unlicensed channel access and physical channel design are considered for FR1, and only beam management is considered for licensed spectrum. FR2 unlicensed operation with beam management is not considered in Rel-18. In addition, only unicast communication is considered. Other cast types are not considered. Different cast types including groupcast are considered in this disclosure.

In beam-based SL in unlicensed bands, due to channel uncertainty, a signal/channel may not be transmitted due to LBT failure in a certain spatial direction. Even if a signal/channel can be transmitted in a certain spatial direction, the signal/channel may not be received due to interference (e.g., from a hidden node in a certain spatial direction). To cope with this issue, procedures to increase transmitting and/or receiving opportunities in unlicensed beam-based SL system is needed. Due to a unique two-stage control design in SL, there is a need on how to incorporate a TCI framework into SL to increase transmitting and/or receiving opportunities in unlicensed spectrum.

In groupcast, NACK-only HARQ feedback is supported. In unlicensed band, if a NACK is not received, then a Tx UE may assume an ACK. In unlicensed band, due to channel uncertainty, a NACK may not be sent, in this case, a Tx UE may assume that a Rx UE successfully receives the PSSCH. This results in system error and performance degradation. How to incorporate TCI to address this issue in groupcast is needed. A procedure is required to address this issue and improve the performance. In beam-based unlicensed band, it has an additional dimension in a spatial domain in addition to a frequency-time domain and resource selection may be impacted by channel uncertainty and spatial domain. How to incorporate spatial domain into resource selection is needed in beam-based unlicensed bands.

To address the above-discussed and other issues, in some aspects, the present disclosure is directed to systems and methods of sidelink (SL) beam-based mode 2 operation for HARQ. A hybrid acknowledgement/non-acknowledgement (ACK/NACK) scheme may be used with ACKs utilized in addition to (or instead of, depending on implementation) NACKs when LBT failure or channel uncertainty (due to noise, interference, low signal levels, etc.) is high, and with a NACK-only scheme used for high throughput and low latency when LBT failure or channel uncertain is low. In various implementations, ACKs and/or NACKs may be grouped or identify a plurality of received or missing signals, or individual ACKs or NACKs (i.e. one per signal or sequence number) may be utilized. This may be similarly based on channel uncertainty or LBT failure, or any other type and form of channel or device condition or characteristic, in various implementations. Accordingly, devices may dynamically switch between a plurality of HARQ configurations in response to changing channel conditions (e.g., ACK/NACK feedback scheme, NACK-only feedback scheme, shared ACK/NACK feedback scheme, etc.). Other HARQ configuration for feedback schemes may also include shared NACK and individual ACK, shared ACK and individual NACK, or any other such combination of shared and/or individual ACKs and/or NACKs. A HARQ feedback scheme with shared NACK and individual ACK may comprise a feedback scheme with a NACK resource that is shared by multiple SL WTRUs and an ACK resource that is not shared; instead in such implementations, ACK resources are separate and ACK resources are individually used by multiple SL WTRUs, with each ACK resource dedicated to one SL WTRU. In other implementations, a HARQ feedback scheme with shared ACK and individual NACK may comprise a feedback scheme with an ACK resource that is shared by multiple SL WTRUs and a NACK resource that is not shared; instead, NACK resources are separate and NACK resources are individually used by multiple SL WTRUs, with each NACK resource dedicated to one SL WTRU. Various other implementations may include partially shared NACK and individual ACK; partially shared ACK and individual NACK; or partially shared NACK and ACK. In implementations of feedback schemes using partially shared NACK and individual ACK, more than one NACK resource may be used for multiple SL WTRUs, and some SL WTRUs may share a single NACK resource. For example, a first subset of SL WTRUs may use a first NACK resource and a second subset of SL WTRUs may use a different second NACK resource. Similarly, in implementations of feedback schemes using partially shared ACK and individual NACK, more than one ACK resource may be used for multiple SL WTRUs, and some SL WTRUs may share a single ACK resource. For example, a first subset of SL WTRUs may use a first ACK resource and a second subset of SL WTRUs may use a different second ACK resource. In implementations of feedback schemes using partially shared NACK and ACK, more than one NACK resource and more than one ACK resource may be used for multiple SL WTRUs, with some SL WTRUs sharing a single NACK resource and some SL WTRUs (the same or different WTRUs) sharing a single ACK resource. For example, a first subset of SL WTRUs may use a first NACK resource and a second subset of SL WTRUs may use a different second NACK resource, and a third subset of SL WTRUs may use a first ACK resource and a fourth subset of SL WTRUs may use a different second ACK resource. The first and third subsets of SL WTRUs may be the same or different (including overlapping subsets or completely disjoint subsets), and the second and fourth subsets of SL WTRUs may be the same or different (including overlapping subsets or completely disjoint subsets). For example, a first SL WTRU may be in a first subset with a second SL WTRU using a first shared NACK resource, but may be a second subset with a third SL WTRU (not including the second SL WTRU) using a first shared ACK resource. Accordingly, shared resources may be used by any combination of SL WTRUs, in various implementations.

A UE may perform sidelink TCI based HARQ feedback with hybrid TCI and HARQ feedback.

The UE may be configured or pre-configured with multiple sets of TCIs (e.g. P-TCI and/or S-TCI). UE may be configured or pre-configured with multiple HARQ feedback schemes (e.g. ACK/NACK, NACK-only, etc.).

The UE may be indicated or provided with the TCI(s) to transmit a PSFCH transmission using the beam(s) associated with the TCI(s). If channel uncertainty is greater than a first threshold, the UE may be indicated to use a large set of TCIs (e.g. P-TCI(s) and/or S-TCI(s)). If channel uncertainty is greater than a second threshold, the UE may switch to an individual ACK/NACK-based HARQ feedback scheme.

The UE may be indicated to transmit an individual ACK or NACK based on decoding results. If channel uncertainty is not greater than the second threshold, the UE may switch to a NACK-only HARQ feedback scheme. The UE may be indicated to transmit a NACK only if decoding fails. If channel uncertainty is greater than the first threshold, the UE may be indicated to use a small set of TCIs (e.g. P-TCI(s) only). If channel uncertainty is greater than a third threshold, the UE may switch to an individual ACK/NACK-based HARQ feedback scheme. The UE may be indicated to transmit an individual ACK or NACK based on decoding results.

If channel uncertainty is not greater than the first threshold, the UE may switch to a NACK-only based HARQ feedback scheme. The UE may be indicated to transmit a NACK only if decoding fails.

In an embodiment, methods of beam-based mode 2 operation for HARQ and groupcast in unlicensed shared spectrum are disclosed. In groupcast, NACK-only HARQ feedback is supported. In unlicensed band, if a NACK is not received, then a Tx UE may assume an ACK. In unlicensed band, due to channel uncertainty, a NACK may not be sent. A Tx UE may assume that a Rx UE has received data successfully. However, a Rx UE may not receive data successfully. This could cause performance degradation.

In some implementations, when LBT failure is high, HARQ could be switched to an ACK/NACK-based procedure and switch back to a NACK-only based procedure when LBT failure is low. In some implementations, transmission opportunities for a NACK-only feedback may be increased using more than one PSFCH resource. Currently only one NACK-only resource is used. Such implementations may use more than one PSFCH resource (either in time, frequency or combination) for NACK-only transmission. A method using adaptive reconfiguration or dynamic indication for RP (e.g., resource period, or repetition period) to a small number instead of a large number may be used. In some implementations, more than one beam may be used to send a PSFCH NACK-only. A secondary PSFCH beam may be used in addition to a primary PSFCH beam. This may be used in combination with other methods described herein. In some implementations, SL-SCI with multiple reception TCIs (PSCCH/PSSCH) with primary/secondary TCIs in codepoint of SL MAC CE may be utilized. Primary/secondary TCIs may be associated with a member ID of the group. Primary/secondary TCIs may be associated with different beams, beamwidth, beam parameters, beam characteristics, etc. For example, a primary TCI may be associated with a wide beam and a secondary TCI may be associated with a narrow beam or sub-beam, or vice versa. In another example, a primary TCI may be associated with a beam with high quality (e.g. beam or link quality) or quality of service (QoS) and a secondary TCI may be associated with a beam with medium or low quality (e.g. beam or link quality) or quality of service (QoS), or vice versa. More than one PSFCH resource may be used for ACK and/or NACK. Furthermore, a ACK and/or NACK resource may be shared by multiple UEs and more than one PSFCH resources may be used for shared ACK and/or NACK.

For shared ACK and NACK, if a NACK is not transmitted by a Rx UE or not received by a Tx UE, then an ACK may not be assumed. This is different from a NACK-only approach in which an ACK may be assumed. Shared ACK is also expected by a UE. If only a shared ACK is received, then an ACK is assumed. If both a shared ACK and NACK are not received, then a NACK may be assumed. If both a shared ACK and NACK are received, then a NACK may be assumed.

Another alternative may be to use a common or shared NACK but individual ACK or common or shared ACK but individual NACK. Some partitioning or sub-grouping for ACKs and/or NACKs may also be possible.

A hybrid procedure using TCI and shared ACK/NACK may be used. If channel uncertainty is high, then a large set TCI and ACK/NACK-based may be used. If channel uncertainty is medium high, then a large set TCI and shared ACK/NACK may be used. If channel uncertainty is medium low, then a small set TCI and shared ACK/NACK may be used. If channel uncertainty is low, then a small set TCI and NACK-only may be used.

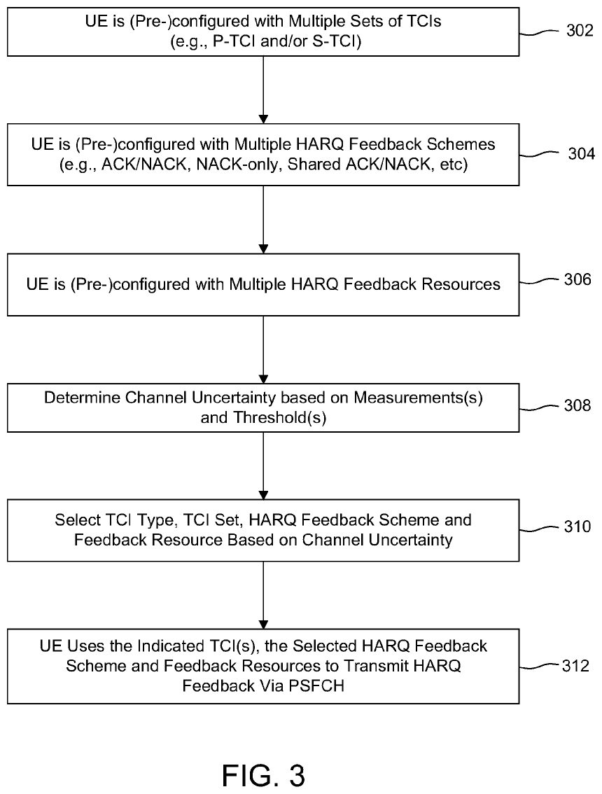

FIG. 3 shows an example method of sidelink TCI based HARQ feedback. A UE may be configured or pre-configured with multiple sets of TCIs (e.g. P-TCIs and/or S-TCIs) at 302. In addition, the UE may be configured or pre-configured with multiple HARQ feedback schemes or procedures (e.g. ACK/NACK, NACK-only, shared ACK/NACK, etc.) at 304. The UE may be configured or pre-configured with multiple HARQ feedback resources at 306.

Channel uncertainty may be determined based on a measurement(s) and a threshold(s) at 308. A TCI type and TCI set may be selected based on channel uncertainty at 310. A HARQ feedback scheme may also be determined based on channel uncertainty in combination with the TCI type and the TCI set at 310. The HARQ feedback resource may be determined based on channel uncertainty in combination with the determined TCI type and TCI set as well as the selected HARQ feedback scheme. The UE may use the indicated TCI(s), the selected HARQ feedback scheme and feedback resources to transmit HARQ feedback via a PSFCH at 312.

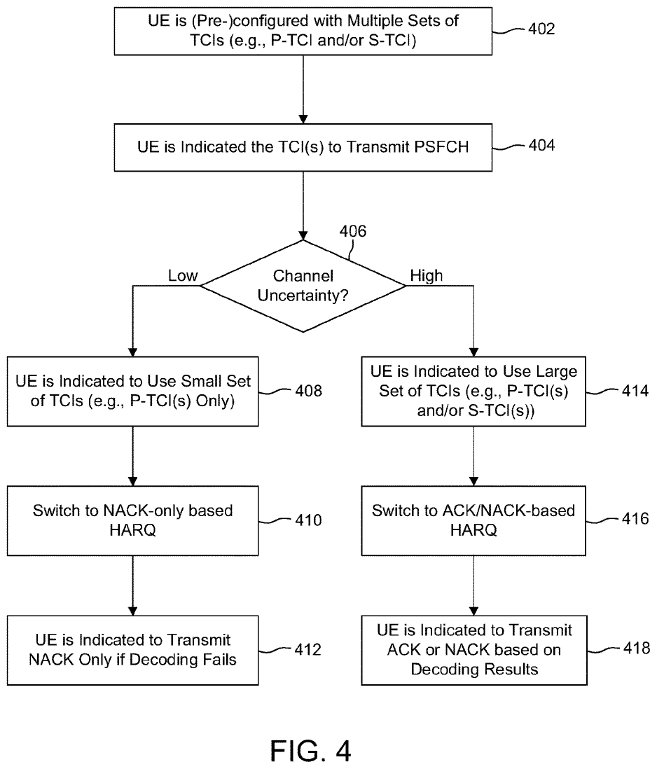

FIG. 4 shows an example method of sidelink TCI based HARQ feedback. A UE may be configured or pre-configured with multiple types of TCIs and multiple sets of TCIs (e.g. one or more primary TCIs (P-TCIs) and/or one or more secondary TCIs (S-TCIs) at 402. The UE may be indicated with the type of TCI, set of TCIs, and which TCI(s) to transmit over a PSFCH at 404. Alternatively, the UE may derive one or more TCI(s) for the PSFCH, based on the configuration for the corresponding PSSCH. An example of such configuration may be a TCI of the corresponding PSSCH, frequency, code, time domain, and/or antenna/antenna port configuration of the corresponding PSSCH. For example, in an embodiment, a Rx UE may derive one or more TCI(s) for the PSFCH transmission, based on the configuration for the corresponding PSSCH reception. In an embodiment, such configuration may be a frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam.

The UE may perform a measurement and determine channel uncertainty at 406. If channel uncertainty is high, the UE may be indicated to use both types of TCIs (e.g. P-TCI and S-TCI) at 414. The UE may be indicated to use a large set of TCIs for P-TCI(s) and/or S-TCI(s). The UE may switch to an ACK/NACK-based HARQ scheme and perform an ACK/NACK-based HARQ procedure at 416. The UE may be indicated to transmit an ACK or NACK based on decoding results at 418. The UE may transmit an ACK if decoding is successful or transmit a NACK if decoding is not successful or fails.

If channel uncertainty is low, at 408 the UE may be indicated to use single type of TCIs (e.g. P-TCI only). The UE may be indicated to use a small set of TCIs for P-TCI(s). The UE may switch to a NACK-only HARQ scheme and perform a NACK-only based HARQ procedure at 410. The UE may transmit a NACK only if decoding is not successful or fails at 412. The UE may not transmit anything if decoding is successful.

Some condition(s) and/or criteria may be used to determine whether a different type or additional TCI(s) may be indicated and used, and whether different a HARQ feedback scheme may be selected and switched. One or multiple thresholds may be used. A threshold may be used to determine the channel uncertainty. For example, if a number of LBT failures is above the threshold, then channel uncertainty may be determined to be high, otherwise, channel uncertainty may be determined to be low. For another example, if measured interference level is above the threshold, then channel uncertainty may be determined to be high, otherwise, channel uncertainty may be determined to be low. For another example, if channel busy ratio (CBR) is above the threshold, then channel uncertainty may be determined to be high, otherwise, channel uncertainty may be determined to be low.

Different thresholds associated with different channel uncertainty measurements and/or metrics may be used. Multiple thresholds may also be considered and utilized. Different conditions and/or criteria may be used either separately or jointly to determine the channel uncertainty. One channel uncertainty measurement and/or metric may be used in combination with another channel uncertainty measurement and/or metric to determine channel uncertainty. The channel uncertainty measurement and/or metric may be one of the following: number of LBT failures, ratio of LBT failures to total measurements, ratio of LBT failures to successes, NACK to ACK ratio, percentage of NACKs, CBR, interference level, or the like.

The threshold(s) may be configured, pre-configured, predefined or indicated.

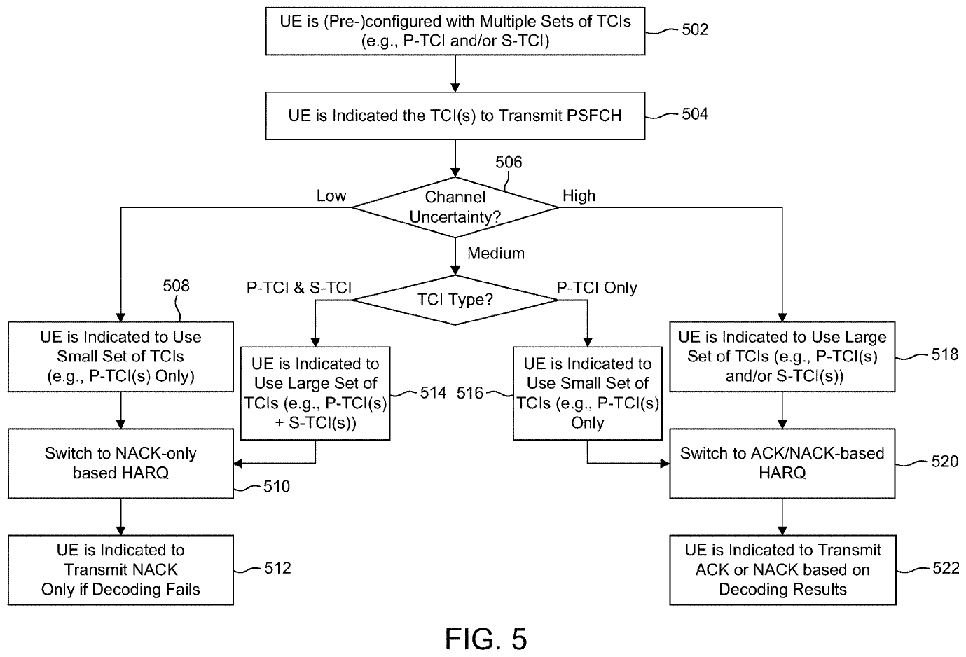

FIG. 5 is an example method of sidelink TCI based HARQ feedback with hybrid TCI and HARQ feedback. At 502, a UE may be configured or pre-configured with multiple types of TCIs and multiple sets of TCIs (e.g. one or more P-TCI and/or one or more S-TCI). At 504, the UE may be indicated the type of TCI, set of TCIs, and which TCI(s) to transmit over a PSFCH. Alternatively, a UE may derive one or more TCI(s) for the PSFCH, based on the configuration for the corresponding PSSCH. An example of such configuration may be the TCI of the corresponding PSSCH, frequency, code, time domain, and/or antenna/antenna port configuration of the corresponding PSSCH. For example, in an embodiment, an Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam.

At 506, the UE may perform a measurement and determine channel uncertainty. Channel uncertainty may be measured based on a number of LBT failures, percentage of LBT failures, number of NACKs, percentage of NACKs, ratio of NACKs to ACKs, interference level, or the like.

Channel uncertainty may be determined with better resolution and granularity than in the method of FIG. 4. There may be multiple levels of channel uncertainty. There may be more than two levels of channel uncertainty. For example, channel uncertainty may be high, medium, or low. For another example, channel uncertainty may be high, medium high, medium low, or low.

If channel uncertainty is high, at 518, the UE may be indicated to use both types of TCIs (e.g. P-TCI and S-TCI). The UE may be indicated to use a large set of TCIs for P-TCI(s) and/or S-TCI(s). At 520, the UE may switch to an ACK/NACK-based HARQ scheme and perform an ACK/NACK-based HARQ procedure. At 522, the UE may be indicated to transmit an ACK or NACK based on decoding results. The UE may transmit an ACK if decoding is successful or transmit a NACK if decoding is not successful or fails.

If channel uncertainty is low, at 508, the UE may be indicated to use a single type of TCIs (e.g. P-TCI). The UE may be indicated to use a small set of TCIs for P-TCI(s). At 510, the UE may switch to a NACK-only HARQ scheme and perform a NACK-only based HARQ procedure. At 512, the UE may transmit a NACK only if decoding is not successful or fails.

If channel uncertainty is medium, the TCI type may be further determined. Either a P-TCI only or both a P-TCI and S-TCI may be used.

If a P-TCI only for TCI type is used, at 516, the UE may be indicated to use a small set of TCIs (e.g. P-TCI(s) only set). The UE may switch to an ACK/NACK-based HARQ procedure. The UE may be indicated to transmit an ACK or NACK based on decoding results.

If a P-TCI and S-TCI for TCI type is used, at 514, the UE may be indicated to use a large set of TCIs (e.g. P-TCI(s) and S-TCI(s) set. The UE may switch to a NACK-only based HARQ procedure. The UE may be indicated to transmit a NACK only if decoding fails or is not successful.

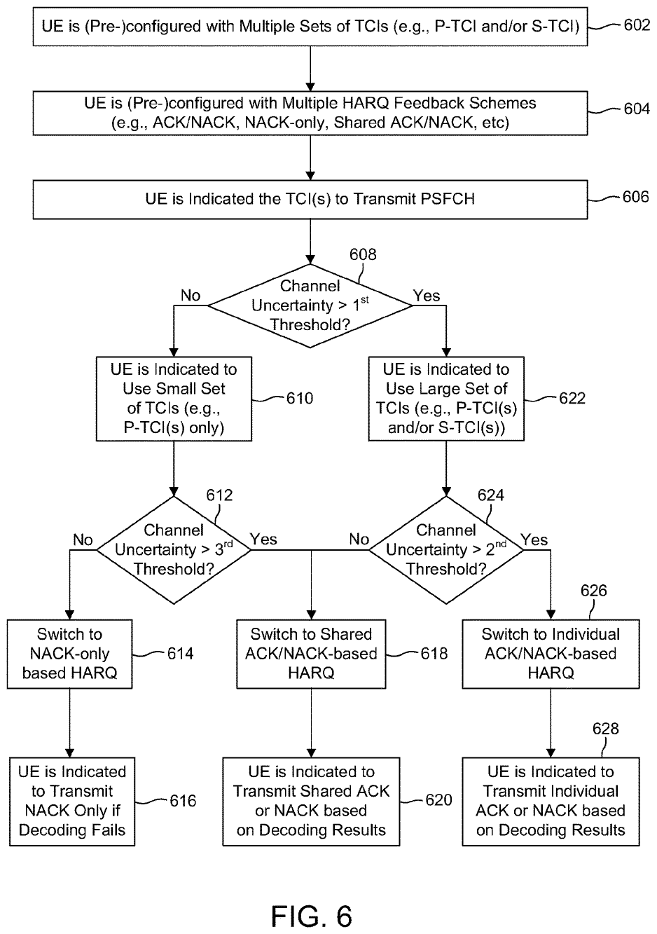

FIG. 6 shows an example method of sidelink TCI based HARQ feedback with hybrid TCI and HARQ feedback.

A UE may be configured or pre-configured with multiple sets of TCIs (e.g. P-TCI and/or S-TCI) at 602. The UE may also be configured or pre-configured with multiple HARQ feedback schemes (e.g. ACK/NACK feedback scheme, NACK-only feedback scheme, shared ACK/NACK feedback scheme, etc.) at 604.

The UE may be indicated with the TCI(s) to transmit over a PSFCH at 606. Alternatively, the UE may derive one or more TCI(s) for the PSFCH, based on the configuration for the corresponding PSSCH. Examples of such configurations may be the TCI of the corresponding PSSCH, frequency, code, time domain, and/or antenna/antenna port configuration of the corresponding PSSCH. For example, in an embodiment, an Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam.

Channel uncertainty may be measured and compared to a first threshold at 608. If channel uncertainty is greater than the first threshold, the UE may be indicated to use a large set of TCIs (e.g. P-TCI(s) and/or S-TCI(s) at 622.

If channel uncertainty is also greater than a second threshold at 624, the UE may switch to an individual ACK/NACK-based HARQ feedback scheme at 626. The UE may be indicated to transmit individual ACK or NACK based on decoding results at 628.

If channel uncertainty is not greater than the second threshold, at 618 the UE may switch to a shared ACK/NACK-based HARQ feedback scheme. At 620, the UE may be indicated to transmit a shared ACK or NACK using a shared resource based on decoding results.

If channel uncertainty is not greater than the first threshold, then at 610, the UE may be indicated to use a small set of TCIs (e.g. P-TCI(s) only).

If channel uncertainty is not greater than the first threshold but is greater than a third threshold at 612, then at 614, the UE may switch to a shared ACK/NACK-based HARQ feedback scheme. At 616, the UE may be indicated to transmit a shared ACK or NACK using a shared resource based on decoding results.

If channel uncertainty is not greater than the first threshold and the third threshold, then at 618, the UE may switch to a NACK-only based HARQ feedback scheme. At 620, the UE may be indicated to transmit a NACK only if decoding fails.

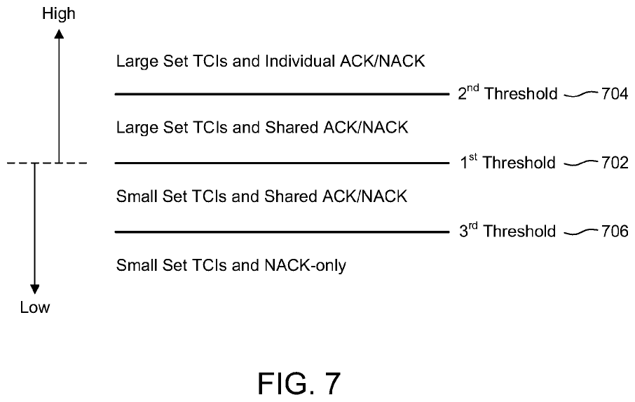

The second threshold may be larger than the first threshold. The first threshold may be larger than the third threshold. Different combinations of sets of TCIs and HARQ feedback schemes may be used accordingly, as shown in FIG. 7, illustrating thresholds 702-706. FIG. 7 is not necessarily to scale, and the thresholds may be evenly or unevenly spaced in various implementations.

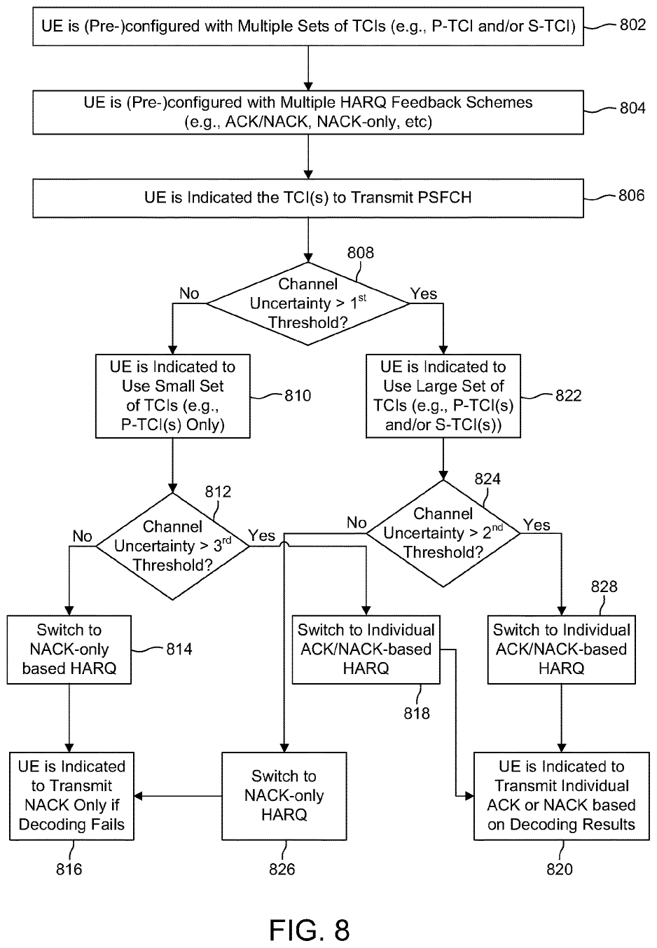

FIG. 8 shows an example method of sidelink TCI based HARQ feedback with hybrid TCI and HARQ feedback. At 802, a UE may be configured or pre-configured with multiple sets of TCIs (e.g. P-TCI and/or S-TCI). The UE may be configured or pre-configured with multiple HARQ feedback schemes (e.g. ACK/NACK feedback scheme, NACK-only feedback scheme, etc.) at 804.

The UE may be indicated with the TCI(s) to transmit over a PSFCH at 806. Alternatively, the UE may derive one or more TCI(s) for the PSFCH, based on the configuration for the corresponding PSSCH. Examples of such configurations may be the TCI of the corresponding PSSCH, frequency, code, time domain, and/or antenna/antenna port configuration of the corresponding PSSCH. For example, in an embodiment, a Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam.

Channel uncertainty may be measured and compared to a first threshold at 808. If channel uncertainty is greater than the first threshold, at 822, the UE may be indicated to use a large set of TCIs (e.g. P-TCI(s) and/or S-TCI(s).

If channel uncertainty is greater than the first threshold and a second threshold at 824, the UE may switch to an individual ACK/NACK-based HARQ feedback scheme at 828. At 820, the UE may be indicated to transmit an individual ACK or NACK based on decoding results. If channel uncertainty is not greater than the second threshold, at 826, the UE may switch to a NACK-only HARQ feedback scheme. At 816, the UE may be indicated to transmit a NACK only if decoding fails.

If channel uncertainty is not greater than the first threshold, then at 810, the UE may be indicated to use a small set of TCIs (e.g. P-TCI(s) only).

If channel uncertainty is greater than the first threshold and a third threshold 812, then at 818, the UE may switch to an individual ACK/NACK-based HARQ feedback scheme. At 820, the UE may be indicated to transmit an individual ACK or NACK based on decoding results. If channel uncertainty is not greater than the third threshold, at 814, the UE may switch to a NACK-only based HARQ feedback scheme. At 816, the UE may be indicated to transmit a NACK only if decoding fails.

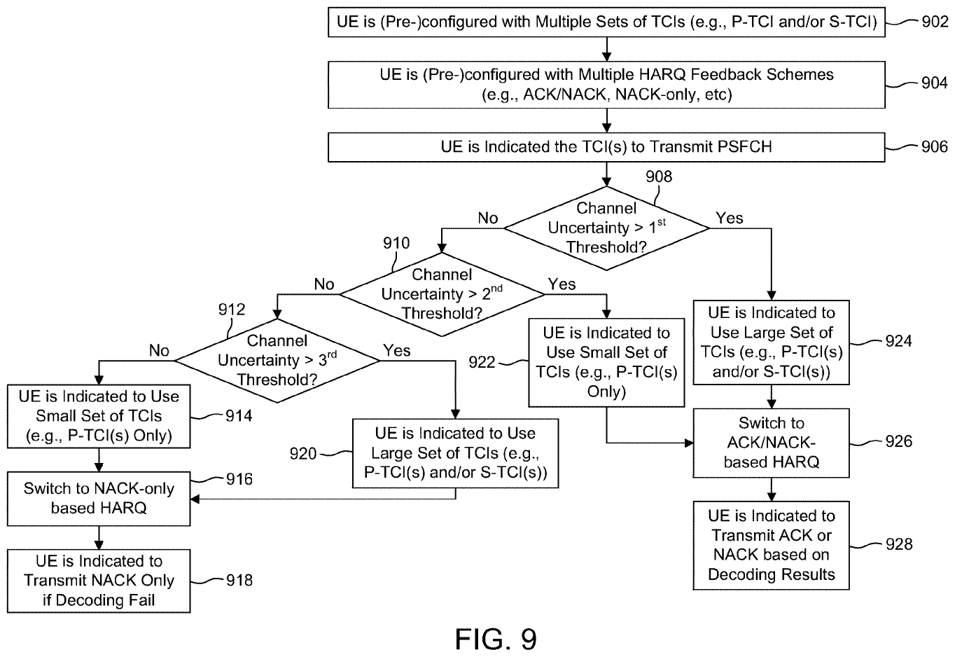

FIG. 9 shows an example method of sidelink TCI based HARQ feedback with hybrid TCI and HARQ feedback. The UE may be configured or pre-configured with multiple sets of TCIs (e.g. P-TCI and/or S-TCI) at 902. At 904, the UE may be configured to pre-configured with multiple HARQ feedback schemes (e.g. ACK/NACK, NACK-only feedback schemes, etc.). The UE may be indicated with the TCI(s) to transmit over the PSFCH at 906. Alternatively, the UE may derive one or more TCI(s) for the PSFCH, based on the configuration for the corresponding PSSCH. Examples of such configurations may be the TCI of the corresponding PSSCH, frequency, code, time domain, and/or antenna/antenna port configuration of the corresponding PSSCH. For example, in an embodiment, a Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam.

The channel uncertainty may be measured and compared to a first threshold at 908. If channel uncertainty is greater than the first threshold, at 924, the UE may be indicated to use a large set of TCIs (e.g. P-TCI(s) and/or S-TCI(s)). At 926, the UE may switch to a ACK/NACK-based HARQ feedback scheme. At 928, the UE may be indicated to transmit an ACK or NACK based on decoding results. The UE may use a large set of TCIs and an ACK/NACK-based feedback scheme to enhance the performance in shared spectrum.

If channel uncertainty is not greater than the first threshold, at 910, a second threshold may be checked. If channel uncertainty is greater than the second threshold, then at 922, the UE may be indicated to use a small set of TCIs (e.g. P-TCI(s) only) to reduce overhead. At 926, the UE may switch to an ACK/NACK-based HARQ feedback scheme. At 928, the UE may be indicated to transmit an ACK or NACK based on decoding results.

If channel uncertainty is not greater than the second threshold, at 912, a third threshold may be checked. If channel uncertainty is greater than the third threshold, at 920, the UE may be indicated to use a large set of TCIs (e.g. P-TCI(s) and/or S-TCI(s)). At 916, the UE may switch to a NACK-only based HARQ feedback scheme. At 918, the UE may be indicated to transmit a NACK only using a large number of beams if decoding fails.

If channel uncertainty is not greater than the third threshold, at 914, the UE may be indicated to use a small set of TCIs (e.g. P-TCI(s) only). At 916, the UE may switch to a NACK-only based HARQ feedback scheme. At 918, the UE may be indicated to transmit a NACK only using a small number of beams if decoding fails.

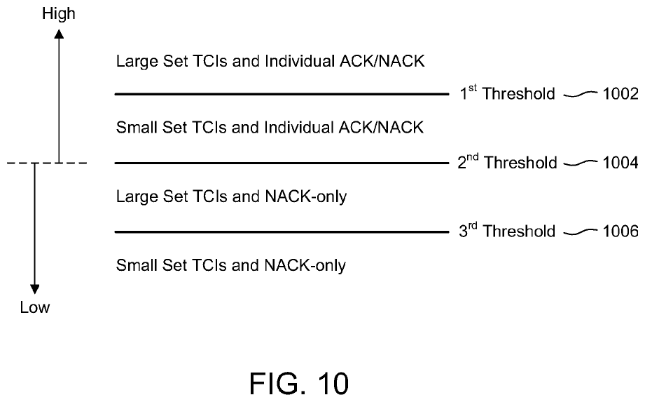

In this case the first threshold 1002 may be larger than the second threshold 1004 and the second threshold may be larger than the third threshold 1006, as shown in FIG. 10. FIG. 10 is not necessarily to scale, and the thresholds may be evenly or unevenly spaced in various implementations.

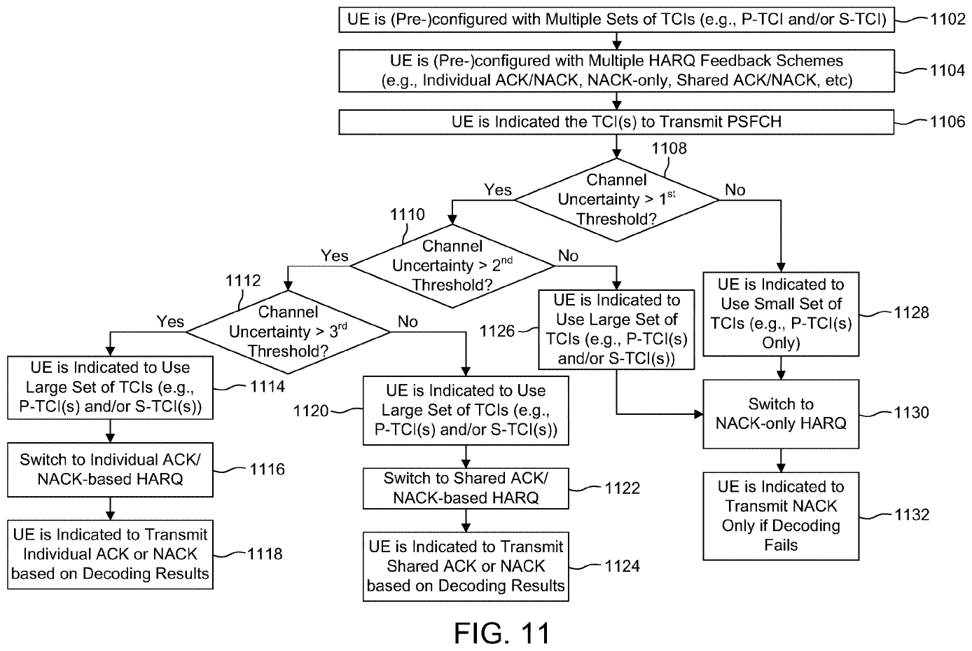

FIG. 11 shows an example method of sidelink TCI based HARQ feedback with hybrid TCI and HARQ feedback. A UE may be configured or pre-configured with multiple sets of TCIs (e.g. P-TCI and/or S-TCI) at 1102. The UE may be configured to pre-configured with multiple HARQ feedback schemes (e.g. individual ACK/NACK, NACK-only, shared ACK/NACK, etc.) at 1104. At 1106, the UE may be indicated with the TCI(s) to transmit over a PSFCH. Alternatively, the UE may derive one or more TCI(s) for the PSFCH, based on the configuration for the corresponding PSSCH. Example of such configuration may be the TCI of the corresponding PSSCH, frequency, code, time domain, and/or antenna/antenna port configuration of the corresponding PSSCH. For example, in an embodiment, a Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam.

The UE may measure channel uncertainty as discussed above. At 1108, if channel uncertainty is not greater than a first threshold, then at 1128, the UE may be indicated to use a small set of TCIs (e.g. P-TCI(s) only). At 1130, the UE may switch to a NACK-only HARQ feedback scheme. The UE may be indicated to transmit a NACK only if decoding fails at 1132.

If channel uncertainty is greater than the first threshold, then a second threshold may be checked at 1110. If channel uncertainty is not greater than the second threshold, then at 1126, the UE may be indicated to use a large set of TCIs (e.g. P-TCI(s) and/or S-TCI(s). At 1130, the UE may switch to a NACK-only HARQ feedback scheme. At 1132, the UE may be indicated to transmit a NACK only if decoding fails.

If channel uncertainty is greater than the second threshold, at 1112, a third threshold may be checked.

If channel uncertainty is not greater than the third threshold, at 1120, the UE may be indicated to use a large set of TCIs (e.g. P-TCI(s) and/or S-TCI(s)). At 1122, the UE may switch to a shared ACK/NACK-based HARQ feedback scheme. The UE may be indicated to transmit a shared ACK or NACK based on decoding results at 1124.

If channel uncertainty is greater than the third threshold, at 1114, the UE may be indicated to use a large set of TCIs (e.g. P-TCI(s) and/or S-TCI(s)). The UE may switch to an individual ACK/NACK-based HARQ feedback scheme at 1116. The UE may be indicated to transmit an individual ACK or NACK based on decoding results at 1118.

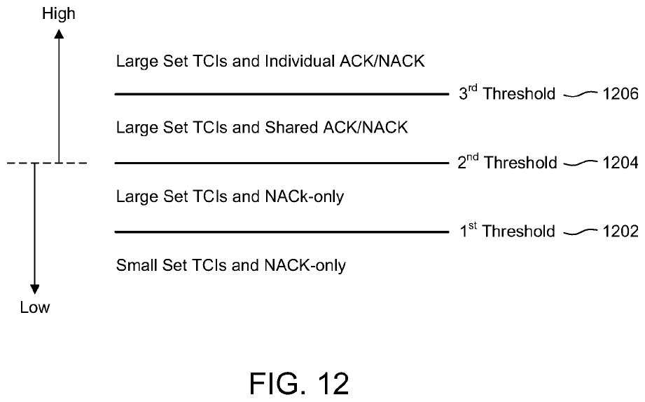

In this case the first threshold 1202 may be smaller than the second threshold 1204 and the second threshold may be smaller than the third threshold 1206, as shown in FIG. 12. FIG. 12 is not necessarily to scale, and the thresholds may be evenly or unevenly spaced in various implementations.

A large set or a small set of TCIs may be predefined. Alternatively, the large set or small set of TCIs may be configured or preconfigured.

A UE may determine channel uncertainty based on an indication, a measurement or combination.

A threshold such as a first threshold, a second threshold and/or a third threshold, or the like, may be configured, pre-configured, predefined or indicated.

A hybrid scheme using a TCI, HARQ feedback and resource allocation may be used to cope with channel uncertainty in a shared spectrum in sidelink.

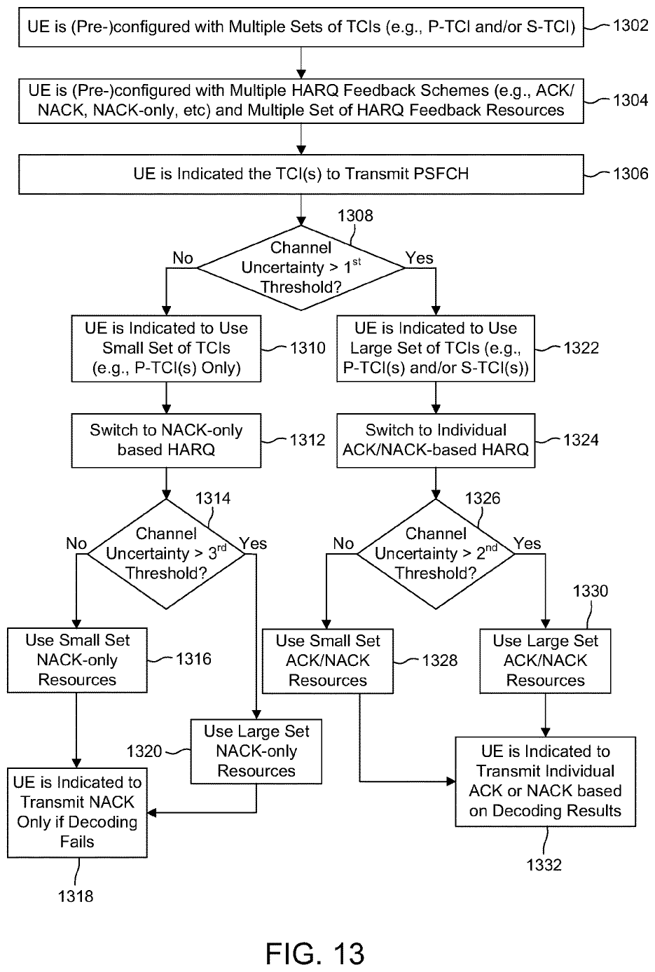

FIG. 13 shows an example method of a hybrid scheme using TCI, HARQ feedback and resource allocation. A UE may be configured or pre-configured with multiple sets of TCIs (e.g. P-TCI and/or S-TCI) at 1302. The UE may be configured or pre-configured with multiple HARQ feedback schemes (e.g., ACK/NACK, NACK-only, etc.) and multiple sets of HARQ feedback resources at 1304. The UE may be indicated with the TCI(s) to transmit over a PSFCH at 1306. Alternatively, the UE may derive one or more TCI(s) for the PSFCH, based on the configuration for the corresponding PSSCH. Examples of such configurations may be the TCI of the corresponding PSSCH, frequency, code, time domain, and/or antenna/antenna port configuration of the corresponding PSSCH. For example, in an embodiment, a Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam.

Channel uncertainty may be measured as discussed above at 1308. If channel uncertainty is greater than a first threshold, then at 1322, the UE may be indicated to use a large set of TCIs (e.g. P-TCI(s) and/or S-TCI(s)). At 1324, the UE may switch to an individual ACK/NACK-based HARQ feedback scheme.

Channel uncertainty may be checked against a second threshold at 1326. If channel uncertainty is greater than the second threshold, then at 1330, a large set of ACK/NACK resources may be used. If channel uncertainty is not greater than the second threshold, then at 1328, a small set of ACK/NACK resources may be used. The UE may be indicated to transmit an individual ACK or NACK using determined ACK/NACK feedback resources based on decoding results at 1332.

If channel uncertainty is not greater than the first threshold, then at 1310, the UE may be indicated to use a small set of TCIs (e.g. P-TCI(s) only). The UE may switch to a NACK-only based HARQ feedback scheme at 1312.

Channel uncertainty may be checked against a third threshold at 1324. If channel uncertainty is greater than the third threshold, at 1320, a large set of NACK-only resources may be used.

If channel uncertainty is not greater than the third threshold, at 1316, a small set NACK-only resources may be used. At 1318, the UE may be indicated to transmit a NACK only using determined NACK-only feedback resources if decoding fails.

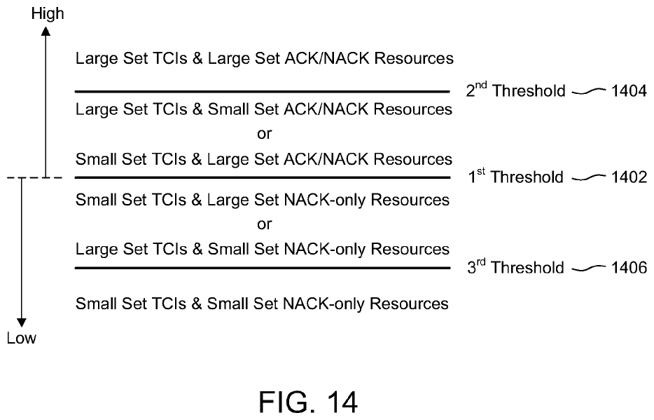

In this case the second threshold 1404 may be larger than the first threshold 1402. The first threshold may be larger than the third threshold 1406, as shown in FIG. 14. FIG. 14 is not necessarily to scale, and the thresholds may be evenly or unevenly spaced in various implementations

UE-assisted SL TCI and HARQ feedback may be used. UE-controlled SL TCI and HARQ feedback may also be considered.

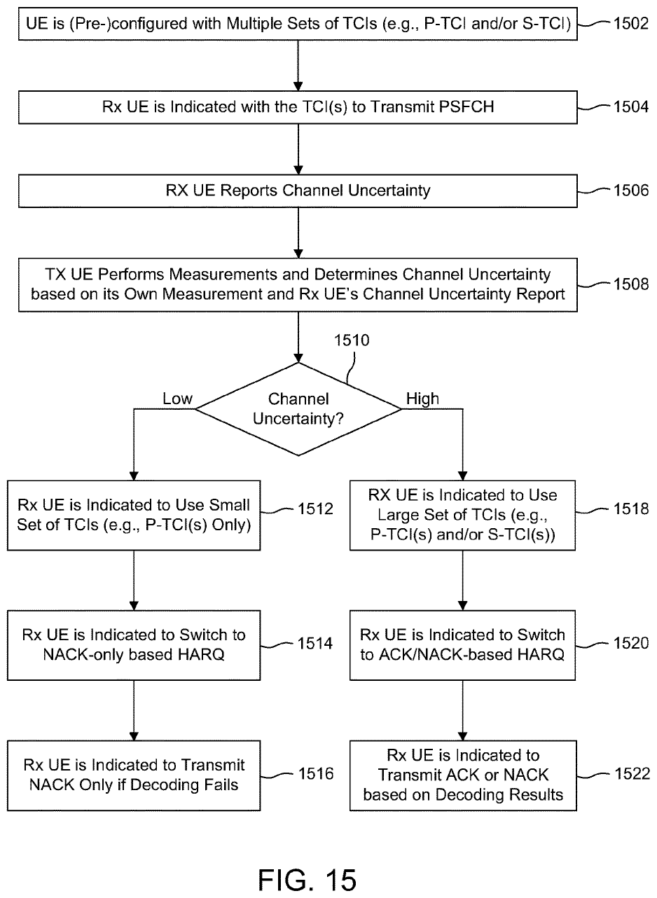

FIG. 15 shows an example method of sidelink UE-assisted TCI and HARQ feedback. A UE may be configured or pre-configured with multiple sets of TCIs (e.g. P-TCI and/or S-TCI) at 1502. A Rx UE may be indicated with the TCI(s) by a Tx UE to transmit over a PSFCH at 1504. Alternatively, the UE may derive one or more TCI(s) for the PSFCH, based on the configuration for the corresponding PSSCH. Example of such configuration may be the TCI of the corresponding PSSCH, frequency, code, time domain, and/or antenna/antenna port configuration of the corresponding PSSCH. For example, in an embodiment, a Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam. A Rx UE may perform a measurement and report channel uncertainty to a Tx UE at 1506.

A Tx UE may perform measurements and determine channel uncertainty based on its own measurement and a Rx UE's channel uncertainty report at 1508.

If channel uncertainty is high at 1510, the Rx UE may be indicated to use a large set of TCIs (e.g. P-TCI(s) and/or S-TCI(s)) at 1518. At 1520, the Rx UE may be indicated to switch to an ACK/NACK-based HARQ procedure. At 1522, the Rx UE may be indicated to transmit an ACK or NACK based on decoding results.

If channel uncertainty is low at 1510, the Rx UE may be indicated to use a small set of TCIs (e.g. P-TCI(s) only) at 1512. At 1514, the Rx UE may be indicated to switch to a NACK-only based HARQ procedure. At 1516, the Rx UE may be indicated to transmit a NACK only if decoding fails.

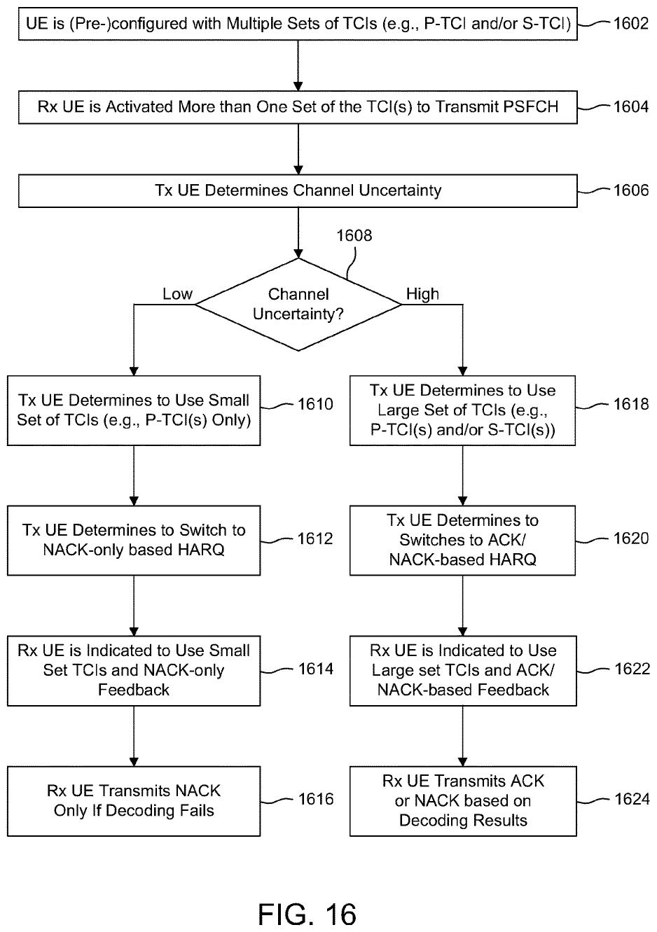

FIG. 16 shows an example method of sidelink UE-controlled TCI and HARQ feedback. A UE may be configured or pre-configured with multiple sets of TCIs (e.g. P-TCI and/or S-TCI) at 1602. A Rx UE may be activated with more than one set of TCIs for a PSFCH transmission at 1604. The Rx UE may be indicated with the set of TCI(s) by a Tx UE to transmit over a PSFCH. Alternatively, the UE may derive one or more TCI(s) for the PSFCH, based on the configuration for the corresponding PSSCH. Example of such configuration may be the TCI of the corresponding PSSCH, frequency, code, time domain, and/or antenna/antenna port configuration of the corresponding PSSCH. For example, in an embodiment, the Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam. A Tx UE may perform the measurement and determine channel uncertainty at 1606.

If channel uncertainty is high at 1608, the Tx UE may determine to use a large set of TCIs (e.g. P-TCI(s) and/or S-TCI(s) at 1618. At 1620, the Tx UE may determine to switch to an ACK/NACK-based HARQ procedure. At 1622, the Rx UE may be indicated to use a large set TCIs and ACK/NACK-based feedback. At 1624, the Rx UE may transmit an ACK or NACK based on decoding results.

If channel uncertainty is low at 1608, the Tx UE may determine to use a small set of TCIs (e.g. P-TCI(s) only) at 1610. At 1612, the Tx UE may determine to switch to a NACK-only based HARQ procedure. At 1614, the Rx UE may be indicated to use a small set TCIs and NACK-only feedback. At 1616, the Rx UE may transmit a NACK only if decoding fails.

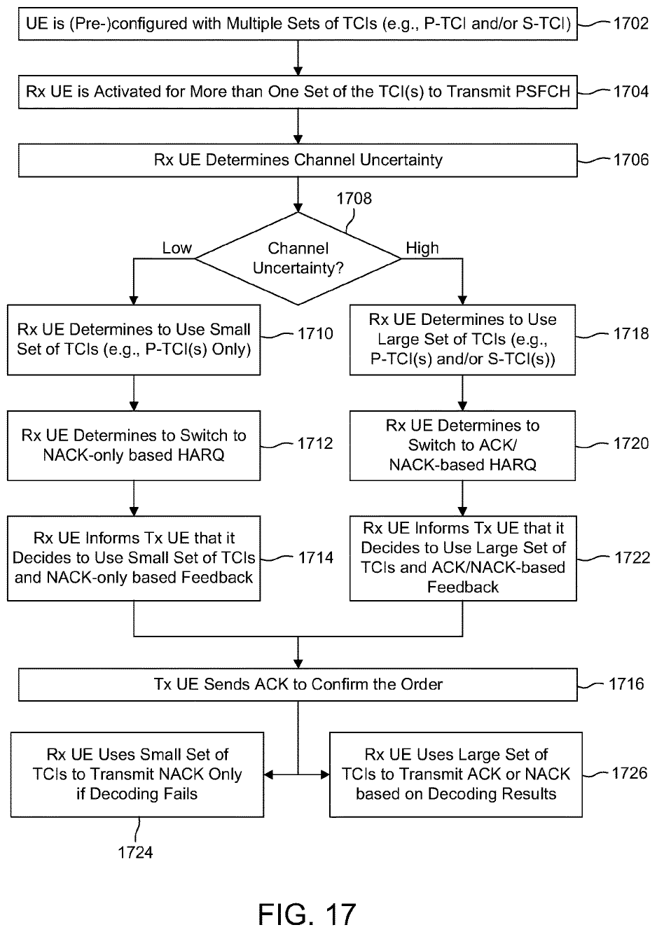

FIG. 17 shows an example method of sidelink UE-controlled TCI and HARQ feedback. At 1702, a UE may be configured or pre-configured with multiple sets of TCIs (e.g. P-TCI and/or S-TCI). At 1704, a Rx UE may be activated for more than one set of the TCI(s) to transmit over a PSFCH. Alternatively, a UE may derive one or more TCI(s) for the PSFCH, based on the configuration for the corresponding PSSCH. Example of such configuration may be the TCI of the corresponding PSSCH, frequency, code, time domain, and/or antenna/antenna port configuration of the corresponding PSSCH. For example, in an embodiment, the Rx UE may derive one or more TCI(s) for the PSFCH transmission, based on the configuration for the corresponding PSSCH reception. In an embodiment, such configuration may be the frequency, code, time domain, and/or antenna/antenna port configuration of the corresponding PSSCH. In an embodiment, such configuration may be one or more TCI(s) of the corresponding PSSCH reception, and/or the associated Rx beam of Tx beam in the direction of Tx UE to the RX beam. The Rx UE may determine channel uncertainty at 1706.

If channel uncertainty is determined to be high at 1708, the Rx UE may determine to use a large set of TCIs (e.g. P-TCI(s) and/or S-TCI(s)) at 1718. At 1720, the Rx UE may determine to switch to an ACK/NACK-based HARQ feedback scheme. At 1722, the Rx UE may inform the Tx UE that it decides to use a large set of TCIs and ACK/NACK-based feedback.

If channel uncertainty is determined to be low at 1708, the Rx UE may determine to use a small set of TCIs (e.g. P-TCI(s) only) at 1710. At 1712, the Rx UE may determine to switch to a NACK-only based HARQ feedback scheme. At 1714, the Rx UE may inform the Tx UE that it decides to use a small set of TCIs and NACK-only based feedback.

The Tx UE may send an ACK to confirm the command from the Rx UE at 1716.

If channel uncertainty is determined to be high, the Rx UE may use a large set of TCIs to transmit an ACK or NACK based on decoding results at 1726.

If channel uncertainty is determined to be low, the Rx UE may use a small set of TCIs to transmit a NACK only if decoding fails at 1724.

For PSFCH transmission, the Rx UE may be indicated which TCI to use to transmit over a PSFCH. The Tx UE may indicate the TCI availability status before PSFCH transmission. If TCI availability status is “available”, then a PSFCH transmission may be transmitted on the TCI at the Rx UE. If TCI availability status is “unavailable”, then a PSFCH transmission may not be transmitted on the TCI at the Rx UE.

Beam width and BWP may be part of procedures or schemes to choose from based on channel condition and channel uncertainty. For example, if channel uncertainty is high, then a narrower beam width may be selected and used. Otherwise, if channel uncertainty is low, then a wider beam width may be selected and used. If channel uncertainty is high, then a BWP with less LBT failures may be selected, switched and used. Otherwise, if channel uncertainty is low, then a new BWP may be selected and used. The same BWP may still be used.

Measurement for channel uncertainty may be performed at a Rx UE, a Tx UE or both. Channel uncertainty may be determined separately at a Rx UE, a Tx UE or jointly at both a Tx and a Rx UE. A Rx UE may assist the TCI and SL HARQ procedure. Alternatively, a Tx UE or Rx UE may control the TCI and HARQ procedure.

A SL HARQ feedback resource may be a frequency/time resources and may include BWP. BWP may also be dynamically selected and determined to optimize the performance based on channel uncertainty in shared spectrum.

Chanel uncertainty may be determined based on the following: number of LBT failures, ratio of LBT failures to total measurements, ratio of LBT failures to successes, NACK to ACK ratio, percentage of NACKs, channel busy ratio (CBR), interference level, or the like, or combination.

A channel uncertainty measurement may be one of the following: number of LBT failures, ratio of LBT failures to total measurements, ratio of LBT failures to successes, NACK to ACK ratio, percentage of NACKs, CBR, interference level, or the like.

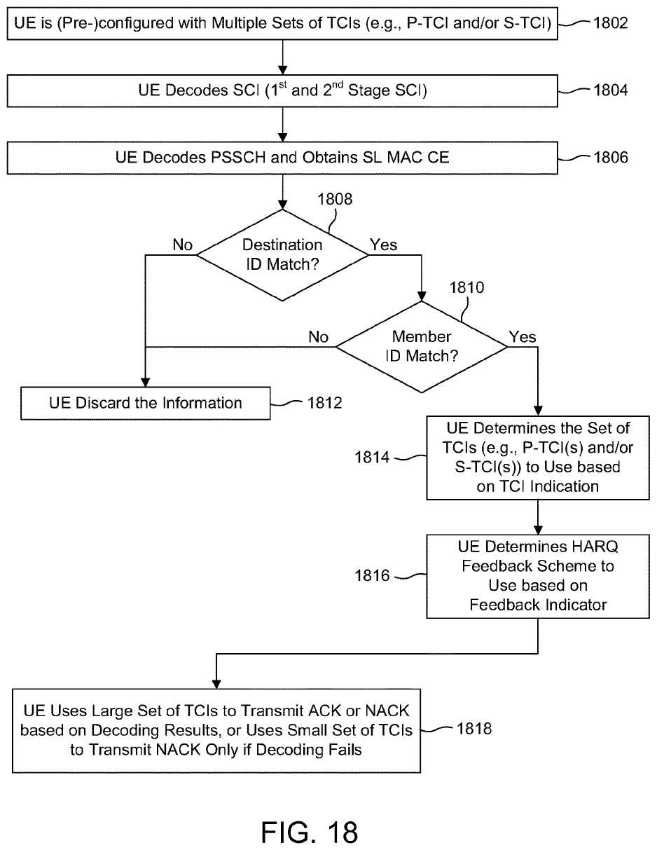

FIG. 18 shows an example method of TCI indication and feedback scheme indication. At 1802, a UE may be configured or pre-configured with multiple sets of TCIs (e.g. P-TCI and/or S-TCI). At 1804, the UE may decode a SCI (e.g. first and second stage SCI). The UE may decode a PSSCH and obtain a SL MAC CE at 1806.

The UE may determine if a destination ID matches the decoded information at 1808. If a destination ID matches, the UE may further check a member ID at 1810.

If the member ID matches, the UE may determine the set of TCIs (e.g. P-TCI(s) and/or S-TCI(s) to use based on TCI information at 1814. The UE may determine a HARQ feedback scheme to use based on a HARQ feedback indicator at 1816. The UE may use a large set of TCIs to transmit ACKs/NACKs based on decoding results, or may use a small set of TCIs to transmit NACKs if decoding fails at 1818.

If member IDs do not match, the UE may discard the information at 1812. Similarly, if destination IDs do not match, the UE may discard the information at 1812.

A destination ID may be a destination L1 ID or a destination L2 ID.

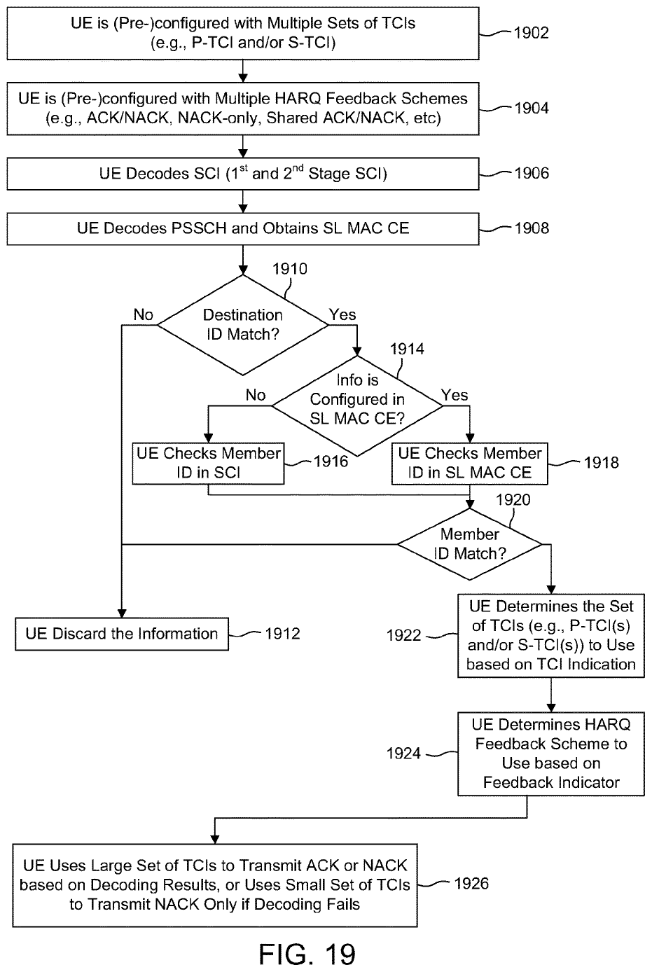

FIG. 19 shows an example method of TCI indication and feedback scheme indication with SL configurable control container. A UE may be configured or pre-configured with multiple sets of TCIs (e.g. P-TCI and/or S-TCI) at 1902. The UE may be configured or pre-configured with multiple HARQ feedback schemes at 1904. Such schemes may include ACK/NACK, NACK-only, shared ACK/NACK, or combinations of these or other schemes. At 1906, the UE may decode a SCI (e.g. first and second stage SCI). At 1908, the UE may decode a PSSCH and obtain a SL MAC CE.

If a destination ID matches at 1910, the UE may check a configuration of a SL control container at 1914.

If the SL MAC CE is configured as a SL control container at 1914 and is used to carry a SL control information for TCI and HARQ feedback scheme indicator, the UE may check a member ID in the SL MAC CE at 1918.

If the SCI is configured as a SL control container and is used to carry a SL control information for TCI and HARQ feedback scheme indicator, then UE may check the member ID in the SCI at 1916.

If the member ID matches at 1920, the UE may determine the set of TCIs (e.g. P-TCI(s) and/or S-TCI(s)) to use based on TCI information at 1922. The UE may determine a HARQ feedback scheme to use based on the HARQ feedback indicator at 1924.

If member IDs do not match, the UE may discard the information at 1912. If destination IDs do not match, the UE may discard the information at 1912.

A destination ID may be a destination L1 ID or a destination L2 ID.

In an embodiment, some UEs may use an ACK/NACK-based HARQ feedback scheme and other UEs may use a NACK-only HARQ feedback scheme depending on the channel uncertainty. A Tx UE may indicate the feedback scheme to a Rx UE via a SCI, SL MAC CE, or combination. For example, the Tx UE may indicate a feedback scheme using the SCI (e.g. first stage SCI and/or second stage SCI). A member ID may be used to identify the UE within a group. In SCI-based approach, one embodiment may be that a member ID may be included in the second stage SCI in addition to a destination ID. A Rx UE may receive the SCI, and check the destination ID. If the destination IDs match, the UE may check a member ID. If the member IDs match, the HARQ feedback scheme may be selected or indicated in the second stage SCI.

The association of member IDs and HARQ feedback schemes may be a format as: member ID 1, feedback scheme 1, member ID 2, feedback scheme 2, and so on. Such SL control information for TCI and HARQ feedback scheme may be included in an SCI and/or SL MAC CE.

The association of member IDs and SL TCI information may be a format as: member ID 1, SL TCI information 1, member ID 2, SL TCI information 2, . . . , or the like. The association of member IDs and SL TCI information may be a format as: member ID 1, SL TCI set 1, member ID 2, SL TCI set 2, . . . , or the like.

A feedback scheme indicator may be included in a SCI and SL TCI information or set indication may be included in SL MAC CE.

Alternatively, both a TCI information indication and HARQ feedback scheme indication may be included or carried in a SCI. Both a SL TCI information indication and HARQ feedback scheme indication may be included or carried in SL MAC CE.

Table 1 shows an example of a SL HARQ feedback scheme indication. A SL HARQ feedback scheme indication may be carried in a SCI and/or SL MAC CE.

TABLE 1

| Member ID | SL HARQ feedback scheme |
|---|---|
| 1 | feedback scheme x1 |
| 2 | feedback scheme x2 |
| 3 | feedback scheme x3 |
| . . . | . . . |

Table 2 shows an example of SL TCI information indication. SL TCI information indication may be carried in a SCI and/or SL MAC CE.

TABLE 2

| Member ID | SL TCI |
|---|---|
| 1 | TCI y1 |
| 2 | TCI y2 |
| 3 | TCI y3 |
| . . . | . . . |

A SL HARQ feedback scheme indication may be carried in a SCI and SL TCI information indication may be carried in SL MAC CE. The SL HARQ feedback scheme indication may be carried in a SL MAC CE and SL TCI information indication may be carried in SCI.

Table 3 shows an example of joint SL HARQ feedback scheme and SL TCI information indication. SL TCI information indication and a SL HARQ feedback scheme indication may be carried in a SCI or SL MAC CE. Alternatively, both SL TCI information indication and a SL HARQ feedback scheme indication may be jointly included or carried in a SL MAC CE, or both. SL TCI information indication and a SL HARQ feedback scheme indication may be jointly included or carried in SCI.

TABLE 3

| Member ID | SL HARQ feedback scheme | SL TCI |
|---|---|---|
| 1 | feedback scheme x1 | TCI y1 |
| 2 | feedback scheme x2 | TCI y2 |
| 3 | feedback scheme x3 | TCI y3 |
| . . . | . . . | . . . |

Table 4 shows an example for a SL HARQ feedback scheme indication. This embodiment may reduce the signaling overhead by associating member IDs under a single feedback scheme. Unlike other solutions in which each member ID may be associated with each feedback scheme, this requires more bits to indicate a HARQ feedback scheme. A feedback scheme may be repeatedly indicated if the same feedback scheme is used by multiple UEs. The embodiment removes the repeated indication for HARQ feedback scheme and thus reduces the overhead.

TABLE 4
SL HARQ
feedback

| scheme | Member ID | | | | | | |
|---|---|---|---|---|---|---|---|
| Feedback | Member | Member | Member | Member | Member | Member | . . . |
| scheme 1 | ID z1 | ID z2 | ID z3 | ID z4 | ID z5 | ID z6 | |
| Feedback | Member | Member | Member | Member | Member | Member | . . . |
| scheme 2 | ID w1 | ID w2 | ID w3 | ID w4 | ID w5 | ID w6 | |

Table 5 shows an example for SL TCI information indication. This embodiment may reduce the signaling overhead by associating member IDs under the same TCI(s). Unlike other solutions in which each member ID may associate with each TCI(s), this requires more bits to indicate TCI(s). TCI(s) may be repeatedly indicated if the same TCI(s) is used and shared by multiple UEs. The embodiment removes the repeated indication for TCI information and thus reduces the overhead.

TABLE 5

| SL TCI | | | | | | | |
|---|---|---|---|---|---|---|---|
| informa- | | | | | | | |
| tion | Member ID | | | | | | |
| TCI 1 | Member | Member | Member | Member | Member | Member | . . . |
| | ID z1 | ID z2 | ID z3 | ID z4 | ID z5 | ID z6 | |
| TCI 2 | Member | Member | Member | Member | Member | Member | . . . |
| | ID w1 | ID w2 | ID w3 | ID w4 | ID w5 | ID w6 | |
| TCI 3 | Member | Member | Member | Member | Member | Member | . . . |
| | ID u1 | ID u2 | ID u3 | ID u4 | ID u5 | ID u6 | |
| . . . | . . . | . . . | . . . | . . . | . . . | . . . | . . . |

A Rx UE and/or a Tx UE may receive a SL TCI information indication.

While the use of a plurality of TCIs is described here in terms of a primary TCI and secondary TCI as a means to characterize a plurality of options to describe the relationship between different signals and/or channels (i.e. the relationship between a source signal/channel, and a target signal/channel), the plurality of TCIs to describe the relationship between a source signal/channel and a target signal/channel maybe characterized in many ways for example a primary TCI, a secondary TCI, a tertiary TCI, . . . , kth TCI, etc.

Hierarchical TCIs, where the TCIs are organized in hierarchy, with a hierarchy is a superset of a subset of another hierarchy within the plurality of TCIs. For example, in case of a spatial domain relationship, the plurality of TCIs may be defined according to the granularities (e.g. beam widths) of the beams associated with a target signal/channel and the granularities of the beams (e.g. beam width) associated with a source signal/channel. For example, for a first level in the hierarchy, the beam associated with a target signal may be a first width beam, and the beam associated with a source signal/channel may also be a first width beam. For a second level in the hierarchy, the beam associated with a target signal may be a second width beam, and the beam associated with a source signal/channel may also be a second width beam, and so forth. A first width beam may mean a beam of a first width, a second width beam may mean a beam of a second width, and so forth.

A primary TCI, a secondary TCI, a tertiary TCI, . . . , kth TCI, etc. may be used. Alternatively, a first TCI, a second TCI, a third TCI, . . . , a kth TCI, etc. may be used.

The terms primary TCI versus secondary TCI, hierarchical TCIs, or a plurality of TCIs comprising of a first TCI, a second TCI, a third TCI, kth TCI and so forth may be used interchangeably in reference to a numbering of a plurality of TCIs that corresponds to the plurality of options that may be configured or signaled, to described the relationship between a source signal/channel, and a target signal/channel.

Primary TCI and secondary TCI signaling may also be based on two stage PC5 RRC and SL MAC CE or three stage PC5 RRC, SL MAC CE and SCI. For example, in an embodiment, in the two stages PC5 RRC and SL MAC CE, a Rx UE may receive one or more TCIs through PC5 RRC signaling, then subsequently the Rx UE may receive one or more TCIs through a MAC CE, wherein the one or more TCIs received through the MAC CE is a subset of the one or more TCIs received by the Rx UE via PC5 RRC signaling. In an embodiment and in connection with the three stage PC5 RRC PC5 RRC, SL MAC CE and SCI approach to TCI signaling, a Rx UE may receive one or more TCIs through PC5 RRC signaling, then subsequently the Rx UE may receive one or more TCIs through a MAC CE, wherein the one or more TCIs received through the MAC CE is a subset of the one or more TCIs received by the Rx UE via PC5 RRC signaling. Furthermore, the Rx UE may receive one or more TCIs through a SCI, wherein the one or more TCIs received through the SCI is a subset of the one or more TCIs received by the Rx UE via MAC CE or PC5 RRC signaling. In an embodiment, in the two stage PC5 RRC and SL MAC CE, a Tx UE may transmit one or more TCIs through PC5 RRC signaling, then subsequently the Tx UE may transmit one or more TCIs through a MAC CE, wherein the one or more TCIs transmitted through the MAC CE is a subset of the one or more TCIs transmitted by the Tx UE via PC5 RRC signaling. In an embodiment in connection with the three stage PC5 RRC PC5 RRC, SL MAC CE and SCI approach to TCI signaling, a Tx UE may transmit one or more TCIs through PC5 RRC signaling, then subsequently the Tx UE may transmit one or more TCIs through a MAC CE, wherein the one or more TCIs transmitted through the MAC CE is a subset of the one or more TCIs transmitted by the Tx UE via PC5 RRC signaling. Furthermore, the Tx UE may transmit one or more TCIs through a SCI, wherein the one or more TCIs transmitted through the SCI is a subset of the one or more TCIs transmitted by the Tx UE via MAC CE or PC5 RRC signaling. The number of TCIs that are configured, activated and/or indicated may be different between primary and secondary TCIs.

Sidelink TCI configuration in shared spectrum is disclosed.

A UE may learn about one or more SL TCIs for the reception of a first stage SCI and a second stage SCI reception through one or more of the following methods.

SL TCI(s) for a first stage SCI and a second stage SCI may be (pre) configured in the UE.

TCI(s) for a first stage SCI and a second stage SCI may be separately (pre) configured in the UE. For example, in an embodiment, a first SL TCI is (pre) configured in the UE for the first stage SCI, and a second TCI is (pre) configured in the UE for the second stage SCI. The UE uses the first TCI to derive a suitable beam for the reception of the first stage SCI. Similarly, the UE uses the second TCI to derive a suitable beam for the reception of the second stage SCI.

TCI(s) for first stage SCI and second stage SCI may be jointly (pre) configured in the UE. For example, in an embodiment, a joint TCI is (pre) configured in the UE and the UE uses the joint TCI to derive a suitable beam for the reception of the first stage SCI, and a suitable beam for the reception of the second stage SCI.

SL TCI(s) for the first stage SCI may be (pre) configured in the UE, herein denoted as first TCI(s).

The UE may use the first TCI for the first stage SCI to derive a second TCI for the second stage SCI.

In an embodiment, the first TCI and the second TCI are separate TCIs. The UE uses the first TCI to derive a suitable beam for the reception of the first stage SCI. Similarly, the UE uses the second TCI to derive a suitable beam for the reception of the second stage SCI.

In an embodiment, the first TCI and the second TCI are a joint TCI. The UE uses the joint TCI to derive a suitable beam for the reception of the first stage SCI, and a suitable beam for the reception of the second stage SCI.

Similarly, in terms of activation of TCI(s), one or more of the following methods may be considered.

SL TCI(s) for a first stage SCI and a second stage SCI may be activated in the UE.

TCI(s) for the first stage SCI and second stage SCI may be separately activated in the UE. For example, in an embodiment, a first SL TCI is activated in the UE for the first stage SCI, and a second TCI is activated in the UE for the second stage SCI. The UE uses the first TCI to derive a suitable beam for the reception of the first stage SCI. Similarly, the UE uses the second TCI to derive a suitable beam for the reception of the second stage SCI.

TCI(s) for first stage SCI and second stage SCI may be jointly activated in the UE. For example, in an embodiment, a joint TCI is activated in the UE and the UE uses the joint TCI to derive a suitable beam for the reception of the first stage SCI, and a suitable beam for the reception of the second stage SCI.

SL TCI(s) for the first stage SCI may be activated in the UE, herein denoted as first TCI(s).

The UE may use the first TCI for the first stage SCI to derive a second TCI for the second stage SCI.

In an embodiment, the first TCI and the second TCI are separate TCIs. The UE uses the first TCI to derive a suitable beam for the reception of the first stage SCI. Similarly, the UE uses the second TCI to derive a suitable beam for the reception of the second stage SCI.

In an embodiment, the first TCI and the second TCI are a joint TCI. The UE uses the joint TCI to derive a suitable beam for the reception of the first stage SCI, and a suitable beam for the reception of the second stage SCI.

Both two stage PC5 RRC and SL MAC CE or three stage PC5 RRC, SL MAC CE and SCI as signaling approaches to configuration and activation of TCIs in a UE as described herein also applies to the TCIs for the first stage SCI and the second stage SCI as described herein.

In two stage SL TCI indication, PC5 RRC may be used to configure a set of SL TCI states and a SL MAC CE may be used to indicate the exact SL TCI state(s) among the configured set of SL TCI states for the UE. In three stage SL TCI indication, PC5 RRC may be used to configure SL TCI states, a SL MAC CE may be used to activate a subset of SL TCI states among the configured set of SL TCI states, and SCI (e.g. the 1st stage SCI, 2nd stage SCI) may be used to indicate the exact SL TCI state(s) among the activated subset of SL TCI states for the UE. The two stage and/or three stage SL TCI indication may be used to indicate SL TCI state(s) for a SL data channel (e.g. PSSCH.) Such two stage and/or three stage SL TCI indication may also be used to indicate SL TCI state(s) for a SL control channel (e.g. PSCCH). In addition such two stage and/or three stage SL TCI indication may also be used for a same carrier scheduling or cross carrier scheduling. Furthermore, such two stage and/or three stage SL TCI indication may also be used for a same slot scheduling or cross slot scheduling.

Other design embodiments for sidelink TCI are disclosed.

Hereinafter, the term SL TCI state or for short TCI state may be used as a configuration element or information element (e.g. SL TCI-State or SL TCI-State-r18, SL TCI-State-r19 or SL TCI-State-r20, etc.), including one or more RS, corresponding QCL type(s), etc. One or more TCI may be determined or derived from a TCI state. For example, a TCI in the transmission direction of UE1 to UE2, or in the transmission direction of UE2 to UE1 may be determined from a TCI state.

The term SL TCI codepoint may be used herein as an allowed value of a SL TCI field in a DCI or in a SCI. A SL TCI codepoint may map to one or more SL TCI states (e.g. multiple SL TCI states used for either TCI for UE1 to UE2 transmission direction, or TCI for UE2 to UE transmission direction, or one SL TCI state used for TCI for UE1 to UE2 transmission direction, and one TCI state used for TCI for UE2 to UE1 transmission direction). A SL TCI codepoint may map to one or more SL TCIs (e.g. one TCI for UE1 to UE2 transmission direction and one TCI for UE2 to UE1 transmission direction). A TCI state may correspond to one or more TCIs.

Both TCI for UE2 to UE1 transmission direction, and TCI for UE1 to UE2 transmission direction may be derived from the same TCI state. For example the UE2 may use the same SL RS to determine a UE2 Rx beam or UE1 Tx beam for UE1 to UE2 transmission direction, as well as to determine a UE2 Tx beam for UE2 to UE1 transmission direction. In this case, a joint pool (set) of TCI states may be configured for both UE1 to UE2 transmission direction as well as UE2 to UE1 transmission direction.

Similarly, separate pools (sets) of TCI states may be configured (i.e. one pool of TCI states for the transmission direction of UE1 to UE2 and another pool of TCI states for the transmission direction of UE2 to UE1). For example, a first SL RS may be used to determine UE2 Rx beam or UE1 Tx beam for UE1 to UE2 transmission direction, while a second SL RS may be used to determine U2 Tx beam for UE2 to UE1 transmission direction.

SL TCI configuration granularity is disclosed.

The TCI may be configured in the Rx UE or the Tx UE at the following granularity level: per component carrier (CC); per bandwidth part (BWP); per control resource set (CORESET); per reference signal (RS) type; per Rx UE (e.g. from the perspective of a Tx UE); per Tx UE (e.g. from the perspective of a Rx UE); per pair Tx and Rx UE; per sidelink link ID; per Service or per destination L2 ID; per pair of Source L2 ID and Destination L2 ID; per source L2 ID; per RS type; per channel (e.g. PSBCH, PSCCH, PSSCH, PSFCH); per resource pool; source and target RS types and physical channels.

The source or target RS types may be one or more of the following: SLSS (S-SSB); SL CSI-RS; SL PT-RS; DMRS for PSCCH or DMRS for PSSCH;

The sources or target channels may be one or more of the following: physical sidelink broadcast channel (PSBCH); physical sidelink control channel (PSCCH); physical sidelink shared channel (PSSCH); physical sidelink feedback channel (PSFCH).

The following QCL types may be considered on sidelink: ‘QCL-TypeA’: {Doppler shift, Doppler spread, average delay, delay spread}; ‘QCL-TypeB’: {Doppler shift, Doppler spread}; ‘QCL-TypeC’: {Doppler shift, average delay}; ‘QCL-TypeD’: {Spatial Rx parameter}. QCL type(s) other than ‘QCL-TypeA’, ‘QCL-TypeB’, ‘QCL-TypeC’ and ‘QCL-TypeD’ may also be considered, without limitation.

One or more of the following nodes may transmit a source RS: a Tx UE (or a helper or an assisting node of a Tx UE) may transmit a source RS to Rx UE, with or without assistance from a Rx UE (or a helper or an assisting node of the Tx UE); a Rx UE (or a helper or an assisting node of a Rx UE) may transmit a source RS to TX UE (for example in support of HARQ feedback over PSFCH), with or without assistance from Tx UE (or a helper or an assisting node of a Rx UE).

One or more of the following nodes may configure, activate or perform both configuration and activation of TCI configuration: the serving cell or a controlling node of the Tx UE may configure TCI information in the Tx UE, with or without assistance information from a Rx UE or serving cell of a Rx UE; the serving cell or a controlling node of the Tx UE may activate (pre) configured TCI information in the Tx UE, with or without assistance information from the Rx UE or serving cell of the Rx UE; the serving cell or a controlling node of the Rx UE may configure TCI information in the Rx UE, with or without assistance information from Tx UE or serving cell of Tx UE; the serving cell or a controlling node of the Rx UE may activate (pre) configured TCI information in the Rx UE, with or without assistance information from the Tx UE or serving cell of the Tx UE; the Tx UE (or a helper or an assisting node of a Tx UE) may configure TCI information into the RX UE, with or without assistance information from the Rx UE or serving cell of the Rx UE; the Tx UE (or a helper or an assisting node of a Tx UE) may activate (pre) configured TCI information in the RX UE, with or without assistance information from the Rx UE or serving cell of the Rx UE; the Rx UE (or a helper or an assisting node of a Rx UE) may configure TCI information in the Tx UE, with or without assistance information from the Rx UE or serving cell of the Rx UE; the Rx UE (or a helper or an assisting node of a Rx UE) may configure (pre) configured) TCI information in the Tx UE, with or without assistance information from the Rx UE or serving cell of the Rx UE.

The methods and solutions described herein may be applied to reception of a sidelink data channel, sidelink control channel, sidelink reference signal, other signals or channels, or the like. The methods and solutions described herein may be applied to transmission of a sidelink data channel, sidelink control channel, sidelink feedback channel, sidelink reference signal, other signals or channels, or the like. The methods and solutions described herein may be applied to different cast types such as unicast, groupcast, multicast, or the like. The methods and solutions described herein may be applied to unlicensed spectrum, shared spectrum, licensed spectrum, or the like. The methods and solutions described herein may be applied to reception and/or transmission of single stage, two-stage or multi-stage communications, for example, two stage sidelink control channel (e.g. the 1st stage SCI and 2nd stage SCI).

In an embodiment, a UE may perform sidelink TCI based HARQ feedback with hybrid TCI and HARQ feedback.

The UE may be configured or pre-configured with multiple sets of TCIs (e.g. P-TCI and/or S-TCI). A UE may be configured or pre-configured with multiple HARQ feedback schemes (e.g. ACK/NACK, NACK-only, etc.).

The UE may be indicated a TCI(s) to transmit a PSFCH transmission.

If channel uncertainty is greater than a first threshold, thee UE may be indicated to use a large set of TCIs (e.g. P-TCI(s) and/or S-TCI(s).

If channel uncertainty is greater than a second threshold, the UE may switch to an individual ACK/NACK-based HARQ feedback scheme.

The UE may be indicated to transmit an individual ACK or NACK based on decoding results.

If channel uncertainty is not greater than the second threshold, the UE may switch to a NACK-only HARQ feedback scheme.

The UE may be indicated to transmit a NACK only if decoding fails.

If channel uncertainty is greater than the first threshold, the UE may be indicated to use a small set of TCIs (e.g. P-TCI(s) only).

If channel uncertainty is greater than a third threshold, the UE may switch to an individual ACK/NACK-based HARQ feedback scheme.

The UE may be indicated to transmit an individual ACK or NACK based on decoding results.

If channel uncertainty is not greater than the first threshold, the UE may switch to a NACK-only based HARQ feedback scheme.

The UE may be indicated to transmit a NACK only if decoding fails.

Chanel uncertainty may be determined based on one or more of the following: number of LBT failures, ratio of LBT failures to total measurements, ratio of LBT failures to successes, NACK to ACK ratio, percentage of NACKs, channel busy ratio (CBR), interference level, or the like, or combination.

In an embodiment, a UE may perform sidelink TCI based HARQ feedback with a configurable SL control

The UE may be configured or pre-configured with multiple sets of TCIs (e.g. P-TCI and/or S-TCI). The UE may decode a SCI (e.g. first and second stage SCI). The UE may decode a PSSCH and obtain a SL MAC CE.

If a destination ID matches, the UE may check the configuration of a SL control container.

If a SL MAC CE is configured as a SL control container and is used to carry a SL control information for TCI and HARQ feedback scheme indicator, the UE may check a member ID in the SL MAC CE.

If SCI is configured as a SL control container and is used to carry a SL control information for TCI and HARQ feedback scheme indicator, the UE may check a member ID in the SCI.

If the member ID matches, the UE may determine the set of TCIs (e.g. P-TCI(s) and/or S-TCI(s) to use based on TCI information. The UE may determine a HARQ feedback scheme to use based on a HARQ feedback indicator.

If member IDs do not match, the UE may discard the information. If destination IDs do not match, the UE may discard the information.

The destination ID may be destination L1 ID or destination L2 ID.

In some aspects, the present disclosure is directed to a method implemented by a wireless transmit/receive unit (WTRU). The method includes receiving information that indicates a plurality of sidelink (SL) transmission configuration indications (TCIs), wherein the SL TCIs include at least a SL primary TCI (P-TCI) and a SL secondary TCI (S-TCI). The method also includes receiving information that indicates a plurality of hybrid automatic repeat request (HARQ) configurations. The method also includes determining a channel uncertainty. The method also includes determining, based on a comparison of the channel uncertainty to at least one threshold value, a combination of a set of SL TCIs and a HARQ configuration to use for communicating via a sidelink feedback channel, wherein the determined set of SL TCIs are a first SL TCI set or a second SL TCI set, wherein the first SL TCI set is smaller than the second SL TCI set. The method also includes sending a transmission, via a sidelink feedback channel, using the determined set of SL TCIs and using the determined HARQ configuration.

In some implementations, the first SL TCI set comprises SL P-TCIs only. In some implementations, the second SL TCI comprises at least a SL P-TCI and a SL S-TCI.

In some implementations, the HARQ configurations comprise an individual ACK/NACK, a shared ACK/NACK, or a NACK only.

In some implementations, the channel uncertainty is based on a number of listen before talk (LBT) failures, an LBT failure rate, a NACK to ACK ratio, an ACK to NACK ratio, a percentage of NACKs, a percentage of ACKs, a channel busy ratio (CBR), or an interference level, or a combination of any of these.

In some implementations, on a condition that the channel uncertainty is less than a first threshold value, the determination is to use the first set of SL TCIs and a NACK only HARQ configuration. In some implementations, on a condition that the channel uncertainty is greater than a first threshold value and less than a second threshold value, the determination is to use the second set of SL TCIs and a NACK only HARQ configuration. In some implementations, on a condition that the channel uncertainty is greater than a first threshold value and greater than a second threshold value and less than a third threshold value, the determination is to use the second set of SL TCIs and a shared ACK/NACK HARQ configuration. In some implementations, on a condition that the channel uncertainty is greater than a first threshold value and greater than a second threshold value and greater than a third threshold value, the determination is to use the second set of SL TCIs and an individual ACK/NACK HARQ configuration.

In some implementations, a first threshold value is less than a second threshold value, and the second threshold value is less than a third threshold value, wherein the first threshold value indicates a low channel uncertainty and the third threshold value indicates a high channel uncertainty.

In some implementations, the sidelink feedback channel is a physical sidelink feedback channel (PSFCH).

In some implementations, the method includes transmitting an identification of the determined channel uncertainty via the sidelink feedback channel. In some implementations, the method includes transmitting an identification of the determined HARQ configuration via the sidelink feedback channel.

In another aspect, the present disclosure is directed to a wireless transmit/receive unit (WTRU), comprising one or more transceivers; one or more memory devices; and one or more processors. The one or more memory devices may be configured to store information that indicates a plurality of sidelink (SL) transmission configuration indications (TCIs), wherein the SL TCIs include at least a SL primary TCI (P-TCI) and a SL secondary TCI (S-TCI), and information that indicates a plurality of hybrid automatic repeat request (HARQ) configurations. The one or more processors may be configured to determine a channel uncertainty; determine, based on a comparison of the channel uncertainty to at least one threshold value, a combination of a set of SL TCIs and a HARQ configuration to use for communicating via a sidelink feedback channel, wherein the determined set of SL TCIs are a first SL TCI set or a second SL TCI set, wherein the first SL TCI set is smaller than the second SL TCI set; and send a transmission, using the one or more transceivers via a sidelink feedback channel, using the determined set of SL TCIs and using the determined HARQ configuration.

In some implementations, the channel uncertainty is based on a number of listen before talk (LBT) failures, an LBT failure rate, a NACK to ACK ratio, an ACK to NACK ratio, a percentage of NACKs, a percentage of ACKs, a channel busy ratio (CBR), or an interference level, or a combination of any of these.

In some implementations, on a condition that the channel uncertainty is less than a first threshold value, the determination is to use the first set of SL TCIs and a NACK only HARQ configuration. In some implementations, on a condition that the channel uncertainty is greater than a first threshold value and less than a second threshold value, the determination is to use the second set of SL TCIs and a NACK only HARQ configuration. In some implementations, on a condition that the channel uncertainty is greater than a first threshold value and greater than a second threshold value and less than a third threshold value, the determination is to use the second set of SL TCIs and a shared ACK/NACK HARQ configuration. In some implementations, on a condition that the channel uncertainty is greater than a first threshold value and greater than a second threshold value and greater than a third threshold value, the determination is to use the second set of SL TCIs and an individual ACK/NACK HARQ configuration.

In some implementations, the one or more processors are further configured to transmit, using the one or more transceivers, an identification of the determined channel uncertainty or an identification of the determined HARQ configuration.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for use in a wireless transmit/receive unit (WTRU), the method comprising:
receiving first information that indicates a plurality of sidelink (SL) transmission configuration indications (TCIs), wherein the plurality of SL TCIs include at least an SL primary TCI (P-TCI) and an SL secondary TCI (S-TCI);
receiving second information that indicates a plurality of hybrid automatic repeat request (HARQ) configurations;
determining a channel uncertainty;
determining, based on a comparison of the channel uncertainty to at least one threshold value, a combination of a set of SL TCIs and a HARQ configuration, wherein the determined set of SL TCIs is a first SL TCI set or a second SL TCI set, wherein the number of SL TCIs in the first SL TCI set is smaller than the number of SL TCIs in the second SL TCI set; and
sending a transmission, via a sidelink feedback channel, using the determined combination of the set of SL TCIs and HARQ configuration.

2. The method of claim 1, wherein the first SL TCI set comprises one or more SL P-TCIs.

3. The method of claim 1, wherein the second SL TCI comprises at least an SL P-TCI and an SL S-TCI.

4. The method of claim 1, wherein the HARQ configurations comprise an individual acknowledgement (ACK)/negative acknowledgement (NACK), a shared ACK/NACK, or a NACK only.

5. The method of claim 1, wherein the channel uncertainty is based at least in part on a number of listen before talk (LBT) failures, an LBT failure rate, a NACK to ACK ratio, an ACK to NACK ratio, a percentage of NACKs, a percentage of ACKs, a channel busy ratio (CBR), or an interference level.

6. The method of claim 1, wherein on a condition that the channel uncertainty is less than a first threshold value, the determination is to use the first set of SL TCIs and a NACK only HARQ configuration.

7. The method of claim 1, wherein on a condition that the channel uncertainty is greater than a first threshold value and less than a second threshold value, the determination is to use the second set of SL TCIs and a NACK only HARQ configuration.

8. The method of claim 1, wherein on a condition that the channel uncertainty is greater than a first threshold value and greater than a second threshold value and less than a third threshold value, the determination is to use the second set of SL TCIs and a shared ACK/NACK HARQ configuration.

9. The method of claim 1, wherein on a condition that the channel uncertainty is greater than a first threshold value and greater than a second threshold value and greater than a third threshold value, the determination is to use the second set of SL TCIs and an individual ACK/NACK HARQ configuration.

10. The method of claim 1, wherein a first threshold value is less than a second threshold value, and the second threshold value is less than a third threshold value, wherein the first threshold value indicates a low channel uncertainty and the third threshold value indicates a high channel uncertainty.

11. The method of claim 1, wherein the sidelink feedback channel is a physical sidelink feedback channel (PSFCH).

12. The method of claim 1, further comprising:
transmitting an identification of the determined channel uncertainty via the sidelink feedback channel.

13. The method of claim 1, further comprising:
transmitting an identification of the determined HARQ configuration via the sidelink feedback channel.

14. A wireless transmit/receive unit (WTRU) comprising:
a transceiver; and
a processor, wherein:
the transceiver is configured to receive first information that indicates a plurality of sidelink (SL) transmission configuration indications (TCIs), wherein the plurality of SL TCIs include at least an SL primary TCI (P-TCI) and an SL secondary TCI (S-TCI);
the transceiver is further configured to receive second information that indicates a plurality of hybrid automatic repeat request (HARQ) configurations;
the processor is configured to determine a channel uncertainty;
the processor is further configured to determine, based on a comparison of the channel uncertainty to at least one threshold value, a combination of a set of SL TCIs and a HARQ configuration, wherein the determined set of SL TCIs is a first SL TCI set or a second SL TCI set, wherein the number of SL TCIs in the first SL TCI set is smaller than the number of SL TCIs in the second SL TCI set; and
the transceiver is further configured to send a transmission, via a sidelink feedback channel, using the determined set of SL TCIs and using the determined HARQ configuration.

15. The WTRU of claim 14, wherein the channel uncertainty is based at least in part on a number of listen before talk (LBT) failures, an LBT failure rate, a negative acknowledgment (NACK) to acknowledgement (ACK) ratio, an ACK to NACK ratio, a percentage of NACKs, a percentage of ACKs, a channel busy ratio (CBR), or an interference level.

16. The WTRU of claim 14, wherein on a condition that the channel uncertainty is less than a first threshold value, the determination is to use the first set of SL TCIs and a NACK only HARQ configuration.

17. The WTRU of claim 14, wherein on a condition that the channel uncertainty is greater than a first threshold value and less than a second threshold value, the determination is to use the second set of SL TCIs and a NACK only HARQ configuration.

18. The WTRU of claim 14, wherein on a condition that the channel uncertainty is greater than a first threshold value and greater than a second threshold value and less than a third threshold value, the determination is to use the second set of SL TCIs and a shared ACK/NACK HARQ configuration.

19. The WTRU of claim 14, wherein on a condition that the channel uncertainty is greater than a first threshold value and greater than a second threshold value and greater than a third threshold value, the determination is to use the second set of SL TCIs and an individual ACK/NACK HARQ configuration.

20. The WTRU of claim 14, wherein the processor is further configured to transmit, an identification of the determined channel uncertainty or an identification of the determined HARQ configuration.
